(19) United States
(12) Patent Application Publication
(10) Pub. No.: US 2026/0077306 A1
(43) Pub. Date: Mar. 19, 2026

(54) HOUSING AND CERAMIC CELL ARRANGEMENT FOR ELECTROCHEMICAL OXYGEN PURIFIER

(71) Applicant: American Oxygen, LLC, Salt Lake City, UT (US)

(72) Inventors: Dale M. Taylor, Murray, UT (US); Thomas D. Taylor, Bountiful, UT (US); True Thatcher, Murray, UT (US); Chad Lee, Sandy, UT (US)

(73) Assignee: American Oxygen, LLC, Salt Lake City, UT (US)

(21) Appl. No.: 19/329,479

(22) Filed: Sep. 15, 2025

Related U.S. Application Data
(60) Provisional application No. 63/694,700, filed on Sep. 13, 2024.

(51) Int. Cl. B01D 53/32

(52) U.S. Cl. CPC B01D 53/326; B01D 2256/12; B01D 2259/65

(57) ABSTRACT

Systems for oxygen concentration and pressurization. An assembly includes an electrochemical assembly comprising a plurality of ceramic cells, an electrical lead, a refractory layer constructed of an electrically insulating refractory material, and an open housing disposed around the electrochemical assembly, wherein the open housing comprises two opposing sides that permit gas flow through the electrochemical assembly. The assembly is such that the open housing applies a compressive force to the electrochemical assembly that causes the electrical lead to maintain contact with the electrochemical assembly.

### CROSS-REFERENCE TO RELATED APPLICATIONS

This application claims the benefit of U.S. Provisional Patent Application No. 63/694,700, filed Sep. 13, 2024, entitled “CERAMIC OXYGEN GENERATOR,” which is incorporated herein by reference in its entirety, including but not limited to those portions that specifically appear hereinafter, the incorporation by reference being made with the following exception: In the event that any portion of the above-referenced provisional application is inconsistent with this application, this application supersedes the above-referenced provisional application.

### TECHNICAL FIELD

The disclosure relates generally to the concentration, purification, and pressurization of oxygen gas and more particularly relates to ceramic devices for concentrating oxygen gas.

### BACKGROUND

Many industries and applications benefit from oxygen gas or purified oxygen gas 108. Common uses of oxygen gas are in the medical field, in commercial applications, in industrial manufacturing and construction applications, in chemical manufacturing applications, and so forth. Purified oxygen gas 108 serves a key role in many different industries. However, traditional methods for purifying oxygen are time, resource, and energy intensive. It is therefore desirable to develop systems, methods, and devices for purifying oxygen by way of low cost and low energy means.

Oxygen is the only element that supports respiration, and it is required to support life and maintain healthy biological processes. Because oxygen is imperative to life and health, separated oxygen and/or purified oxygen gas 108 is commonly used in medical applications. For example, medical oxygen is used as a basis for virtually all procedures that involve the use of anesthesia, medical oxygen is typically provided to all patients that are experiencing any respiratory distress, and all patients experiencing low blood oxygen levels. Providing purified oxygen gas 108 to a patient can restore the patient's tissue oxygen tension by improving oxygen availability in a wide range of conditions, including cyanosis, shock, sever hemorrhage, carbon monoxide poisoning, major trauma, cardiac arrest, and respiratory arrest. Oxygen can aid in resuscitation of a patient and provides a vital role in sustaining the patient's brain function and tissue health during a time of distress. Hospitals and clinics around the world need a constant ready-to-use supply of purified oxygen gas that can be provided to a patient at any time. Many hospitals, particularly smaller hospitals, or remote hospitals, rely on using individual tanks of oxygen gas. This can be extremely expensive and can be a significant financial burden on some medical facilities. In addition, as oxygen in the tanks are consumed, they must be refilled or replaced with pre-filled tanks, and this creates a risk a given medical facility will run out of their stored oxygen supply. This risk is particularly acute during inclement weather or after a local disaster such as a hurricane, earthquake, flooding, mudslide, forest fire, or other disaster when medical oxygen supplies are most needed. Therefore, it is desirable to provide systems, methods, and devices for generating purified oxygen on-site or near the consumer at a lower cost that is sustainable and requires less energy to produce and maintain and is less susceptible to environmental conditions.

Other important industries that rely on the use of purified oxygen gas 108 include a wide range of industrial manufacturing industries such as chemical manufacturing, raw material refinement, and others. Many manufacturing processes benefit from oxygen enrichment. For example, processes involving combustion are greatly improved by lowering the amount of nitrogen gas and increasing the amount of oxygen gas. The combustion efficiencies will increase due to a drop in heat loss as a result of lower mass flow rates. Further for example, processes involving gasification by which coal, or another carbon-based fuel, is transformed into a synthesis gas, benefit from oxygen enrichment. Therefore, it is desirable to provide low-cost and high efficiency means for generating copious quantities of oxygen gas for use across many different industries.

One traditional method of generating oxygen gas is by way of cryogenic air separation. Historically, this method accounts for over 95% of all oxygen production and is performed at a central production plant and then distributed to end users. Cryogenic air separation is used to produce concentrated oxygen or nitrogen in high volumes. Air is commonly made up of oxygen, nitrogen, argon, carbon dioxide, water vapor, and other particles. Cryogenic air separation is based on each of these components having a different boiling point, i.e., when the component transitions from a liquid state to a gaseous state. In cryogenic air separation, the temperature of air is lowered so that nitrogen and oxygen separate based on their different boiling points. This occurs at around −300° F. If purified oxygen gas 108 is desired, then further distillation is required. Because the air must be lowered to an extremely cold temperature, cryogenic air separation is expensive in terms of money and energy resources. Further, because cryogenic air separation occurs at large production plants and must then be transported by way of cryogenic vessels or pressurized vessels, this method consumes enormous sums of energy and can be expensive for end users.

Another method of generating oxygen gas is by way of pressure swing adsorption. Pressure swing adsorption consumes air into a pressurized tank having zeolites. The zeolites, under pressure, create a dipole that allows for the collection of nitrogen and allows oxygen to pass. Pressure swing adsorption is not well suited for processes that require purified oxygen gas 108, such as gas that is 95% or more oxygen. In some implementations, multi-stage pressure swing adsorption is capable of generating purified oxygen gas 108, but the cost is tremendously high, and it is not a desirable process to perform. Pressure swing adsorption can be implemented on-site by an end user, but it cannot produce high purity or ultra-purified oxygen gas 108 without an enormous increase in cost. This method is typically used for low purity applications with an oxygen concentration of 93% or less.

In view of the foregoing, disclosed herein are systems, methods, and devices for improved oxygen concentration and pressurization.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic illustration of a system for oxygen concentration and pressurization;

FIG. 2 is a perspective view of a stack assembly for outputting purified oxygen gas, wherein the stack assembly includes an electrochemical assembly and a terminal plumbing assembly;

FIG. 3 is a perspective view of a ceramic oxygen generator including a counterflow spiral heat exchanger;

FIG. 4 is a cross-sectional straight-on end view of a triple spiral counterflow heat exchanger to be utilized with a stack assembly comprising a plurality of ceramic electrochemical cells;

FIG. 5 is a cross-sectional straight-on end view of a dual spiral counterflow heat exchanger to be utilized with a stack assembly comprising a plurality of ceramic electrochemical cells;

FIG. 6 is a cross-sectional straight-on end view of a ceramic oxygen generator including a stack assembly disposed within a triple spiral counterflow heat exchanger;

FIG. 7 is a cross-sectional straight-on end view of a ceramic oxygen generator including a stack assembly disposed within a dual spiral counterflow heat exchanger;

FIG. 8 is a cross-sectional straight-on side view of a ceramic oxygen generator including a stack assembly disposed within a triple spiral counterflow heat exchanger;

FIG. 9 is a cross-sectional straight-on side view of a ceramic oxygen generator including a stack assembly disposed within a dual spiral counterflow heat exchanger;

FIG. 10 is an exploded perspective view of a housing assembly for a plurality of ceramic electrochemical cells;

FIG. 11 is an exploded perspective view of a housing assembly for a plurality of ceramic electrochemical cells;

FIG. 12 is a perspective view of a housing assembly for a plurality of ceramic electrochemical cells, wherein an input side of the housing is primarily visible;

FIG. 13 is a perspective view of a housing assembly for a plurality of ceramic electrochemical cells, wherein an input side of the housing is primarily visible, and further wherein a heater and gas diffuser are removed;

FIG. 14 is a perspective view of a housing assembly for a plurality of ceramic electrochemical cells, wherein an input side of the housing is primarily visible;

FIG. 15 is a perspective view of a housing assembly for a plurality of ceramic electrochemical cells, wherein an output side of the housing is primarily visible;

FIG. 16 is a schematic illustration of an aerial top-down view of a cell assembly including a cell, spacer, and a plurality of electrically conductive interconnects;

FIG. 17 is a perspective view of a cell stack comprising a plurality of ceramic cells, wherein a spacer and a plurality of electrically conductive interconnects is disposed in between each pair of adjacent cells;

FIG. 18 is a schematic illustration of a cross-sectional straight-on side view of layers and components of two cells of an electrochemical assembly; and

FIG. 19 is a schematic illustration of a cross-sectional straight-on side view of layers, components, and reactions occurring within and surrounding a cell of an electrochemical assembly.

### DETAILED DESCRIPTION

The present disclosure extends to systems, methods, and devices for oxygen concentration and pressurization. The systems, methods, and devices described herein output purified oxygen gas in a cost efficient and energy efficient manner that is deployable on-demand and eliminates the need for oxygen gas cylinders and cryogenic containers.

Specifically described herein and systems, methods, and devices for a dual function heat exchanger housing for an electrochemical assembly. The electrochemical assembly described herein includes a plurality of ceramic cells that output purified oxygen gas. Further described herein are systems, methods, and devices for a boxed electrochemical assembly design and protective housing for ceramic cells.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

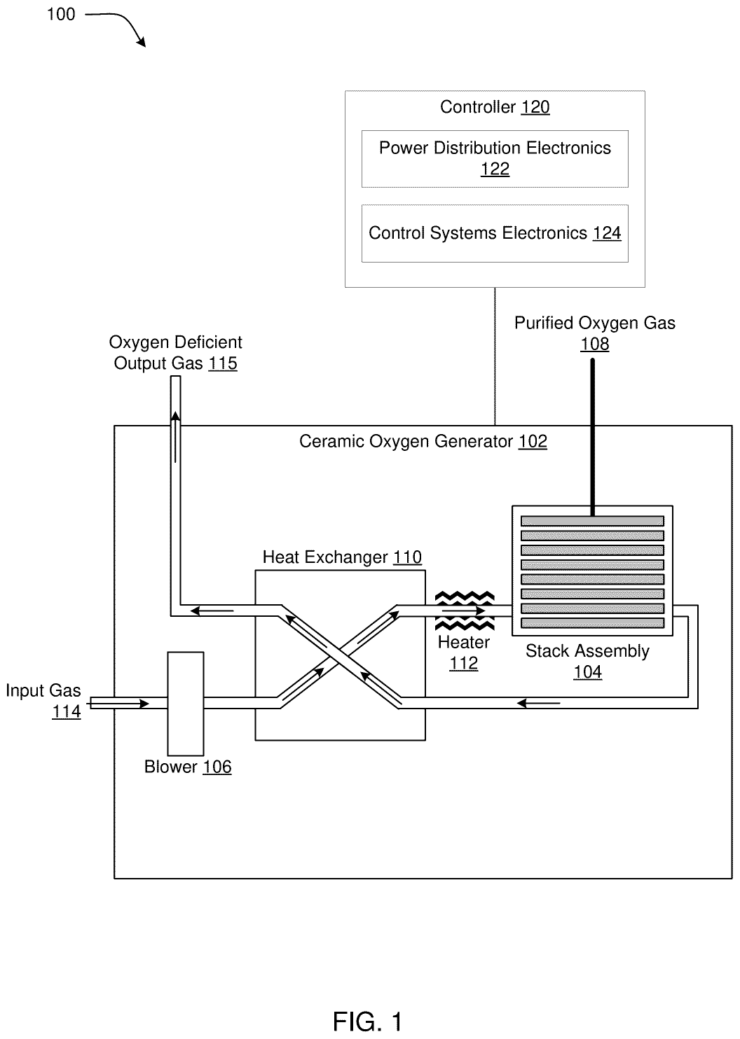

Referring now to the figures, FIG. 1 is a schematic illustration of a system 100 for ceramic oxygen purification. The system 100 includes two major portions, including a controller 120 that operates at ambient temperature, and a ceramic oxygen generator (COG) 102 that operates at elevated temperatures. The controller 120 includes at least power distribution electronics 122 and control systems electronics 124.

The COG 102 receives an input gas 114 and outputs each of an oxygen-deficient output gas 115 and a purified oxygen gas 108. The input gas 114 may include any suitable gas that comprises oxygen, and may specifically include air. The oxygen-deficient output gas may not be entirely deficient of oxygen, but has less oxygen than the input gas 114, because oxygen gas has been removed by the stack assembly 104. The purified oxygen gas 108 may comprise a purity greater than 95% and may specifically comprise a purity greater than 99.9%.

The input gas 114 may be pulled into the COG 102 with a blower 106. The air flow path may be open and unrestricted such that the performance specifications for the blower 106 may be minimal and similar to those of ventilation blowers utilized in residential settings (e.g., about 0.35-0.55 cubic meters per minute).

The input gas 114 is drawn into a heat exchanger 110 and then heated with a heater 112 prior to being processed through a stack assembly 104. The stack assembly 104 includes an electrochemical assembly (see 202) comprising a plurality of ceramic cells (see 206). The stack assembly 104 additionally includes a terminal plumbing assembly (see 208) that comprises metal components and ceramic components to compensate for a differential in CTEs between a metal oxygen port and the ceramic components of the electrochemical assembly.

The stack assembly 104 extracts oxygen from the input gas 114, outputs purified oxygen gas 108 through a central pipe, and adds heat to the input gas 114 because the ion transport process produces waste heat. The stack assembly 104 comprises an impermeable, dense, monolithic ceramic structure. The stack assembly 104 comprises ceramic materials capable of transporting oxygen ions when supplied with an electrical potential. One or more of the ceramic materials within the stack assembly 104 do not conduct electricity but are capable of transporting oxygen if supplied with an electric potential. The ion transport membranes of the stack assembly 104 are made from ion-conducting ceramic oxides, which are insensitive to elevated temperature oxygen service. These ceramic oxide materials can be formed into dense structures, and when constructed into an operational device, may take the shape of a membrane that is gas impermeable. When the ion transport membrane is connected to a “strongback” structure, the ion transport membrane forms a hermetic seal with the purified oxygen gas 108 on one side and the oxygen deficient output gas 115 on the other side.

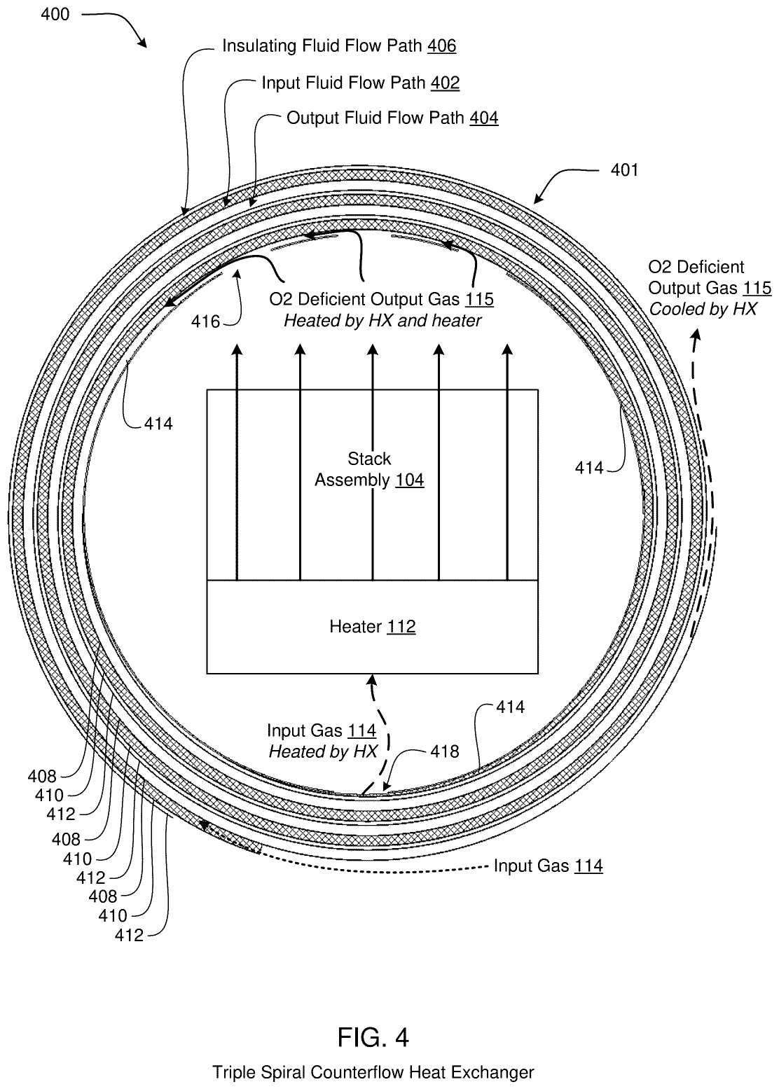

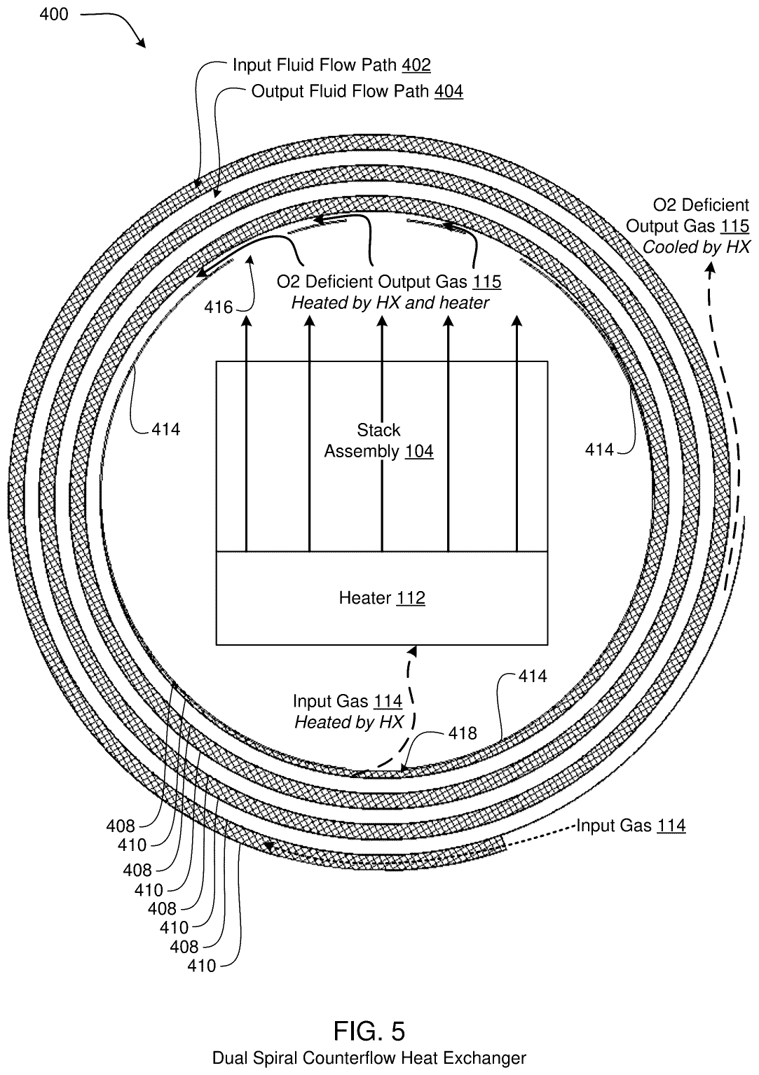

The heat exchanger 110 may comprise a dual-purpose heat exchanger that simultaneously preheats the input gas 114 while cooling the oxygen deficient output gas 115. This arrangement reduces energy consumption and simplifies venting requirements by reducing the temperature of the oxygen deficient output gas 115. The heat exchanger 110 may include any suitable dual-purpose heat exchanger, and may specifically include a counterflow heat exchanger 110. More specifically, the heat exchanger 110 may include either of a triple spiral counterflow heat exchanger (see, e.g., 401 first described in connection with FIG. 4) or a dual spiral counterflow heat exchanger (see, e.g., 501 first described in connection with FIG. 5).

The heater 112 provides a significant amount of heating during transient startup and operates under reduced loads in steady-state operation. The operating temperature for the stack assembly 104 may be from about 500° C. to about 900° C., and this heat is primarily provided by the heater 112 the stack assembly 104 and the heat exchanger 110. The heat exchanger 110 serves an additional purpose of reflecting back thermal energy output by the heater 112 and stack assembly 104. The heat exchanger 110 may be constructed of any suitable material known to reflect thermal energy, and may specifically be constructed of a metal material. The heat exchanger 110 thus serves an insulating function to prevent the loss of thermal energy, via thermal radiation, output by the heater 112.

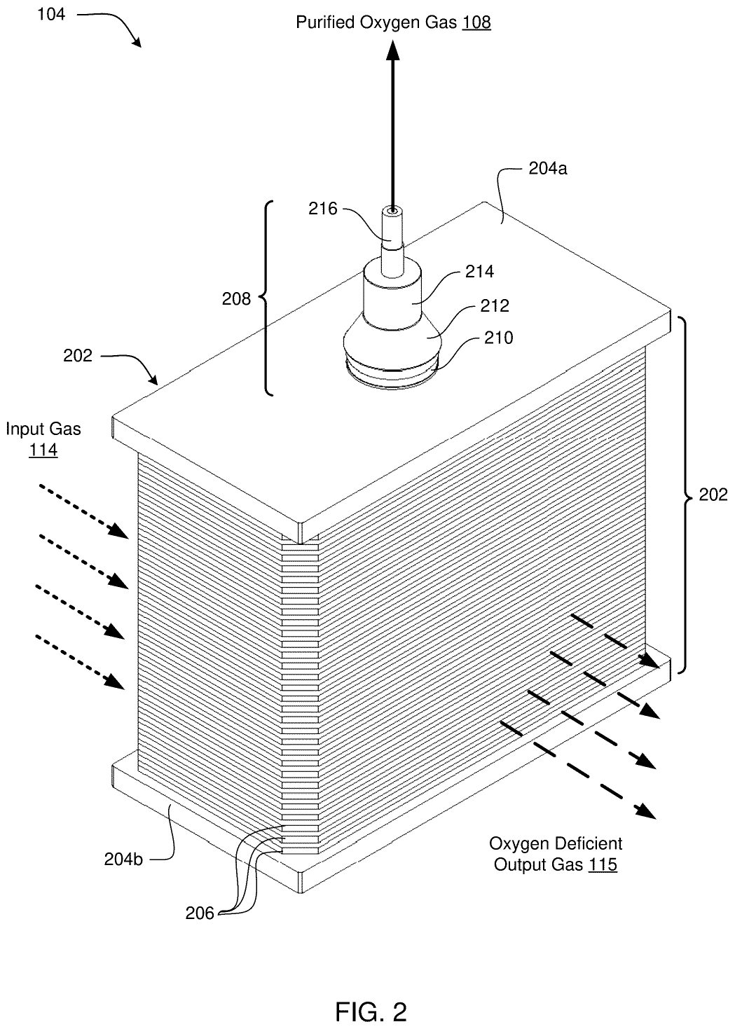

FIG. 2 is a perspective view of the stack assembly 104 for ceramic oxygen generation. The stack assembly 104 includes an electrochemical assembly 202 and a terminal plumbing assembly (TPA) 208. The electrochemical assembly 202 comprises a plurality of ceramic cells 206 that receive the input gas 114 and output each of the purified oxygen gas 108 and the oxygen deficient output gas 115. The TPA 208 reduces mechanical strain placed on the delicate ceramic components of the electrochemical assembly 202, and in particular a first terminal plate 204a, due to a mismatch in coefficients of thermal expansion (CTEs) between the a first terminal plate 204a, or ceramic cells 206 in the case of an electrochemical assembly 202 without a first terminal plate 204a, and a metal output tube.

The electrochemical assembly 202 comprises a plurality of cells 206 sandwiched between a first terminal plate 204a that includes a hole therethrough substantially aligned with a hole therethrough in the TPA 208 and a second terminal plate 204b. The purified oxygen gas 108 is output via a tube stub 216 that feeds into an outlet tube (not shown), and the outlet tube may then feed the purified oxygen gas 108 to one or more of a storage vessel or an end-use.

The electrochemical assembly 202 outputs purified oxygen gas 108 streams in excess of 85% purity at high volumes. The purity of the oxygen flow of the electrochemical assembly 202 may be equivalent to or superior to the purity of the oxygen flow of cryogenic separation systems. The other constituents of air (e.g., nitrogen, argon, carbon dioxide, and excess oxygen) are unaffected by the ion transport membrane of the electrochemical assembly 202.

The plurality of cells 206 each comprises a hole disposed therethrough, and these holes may be aligned to form a central chimney that allows the purified oxygen gas 108 to be delivered through the tube stub 216. The cells 206 accept gaseous molecules when the input gas 114 (may include air or some other oxygen-containing gas) is passed through the electrochemical assembly 202. The cells 206 separate oxygen ions from other components in the input gas 114, such as argon gas, nitrogen gas, carbon dioxide, and others. The purified oxygen gas 108 is harnessed and may be stored in a tank or immediately used. The other non-oxygen components of the input gas 114 (i.e., the oxygen deficient output gas 115) may also be harnessed or may be released into the environment.

The TPA 208 joins the electrochemical assembly 202 to the tube stub 216, and specifically serves to mitigate mechanical stress caused by different thermal expansion properties for the electrochemical assembly 202 and the tube stub 216. The electrochemical assembly 202 comprises cells 206 constructed of a ceramic material, and the tube stub 216 comprises a metal. The ceramic material(s) of the electrochemical assembly 202 comprise a lower coefficient of thermal expansion (CTE) than the metal(s) of the tube stub 216. Thus, during heating, the metal tube stub 216 attempts to expand more than the ceramic electrochemical assembly 202, and this creates compressive stress within the metal and tensile stress within the ceramic. Further, during cooling, the metal contracts more than the ceramic, and this causes tensile stress within the metal and compressive stress within the ceramic. Because ceramics are generally weak under tensile stress, this can lead to cracking and leaking at or near the ceramic-metal joint.

The TPA 208 is designed to mitigate stress at the ceramic-metal joint to prevent the formation of cracks and leaks within the stack assembly 104. The TPA 208 includes a ceramic adapter 210, adapter skirt 212, metal adapter 214, and the tube stub 216. The purified oxygen gas 108 passes through the TPA 208 and exits via the tube stub 216, where it may then feed into an outlet tube to be stored within a vessel or provided directly to an end-use.

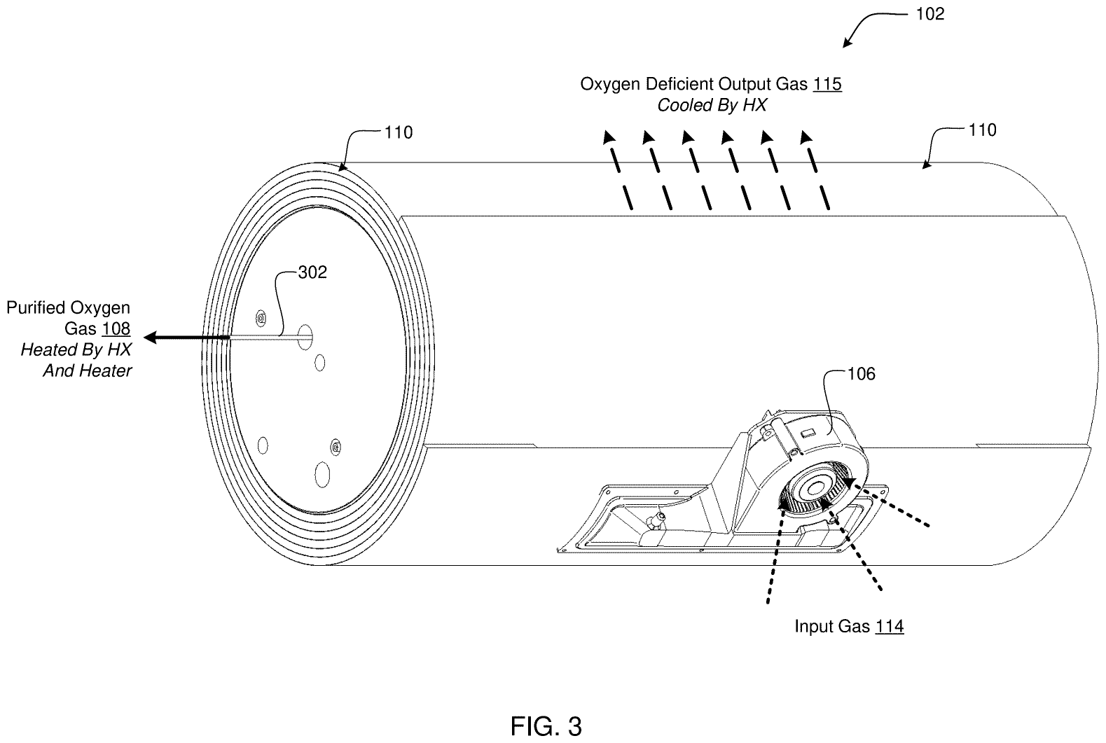

FIG. 3 is a perspective view of a COG 102 that receives the input gas 114 and outputs each of the oxygen-deficient output gas 115 and the purified oxygen gas 108. The view illustrated in FIG. 3 depicts the blower 106 and an exterior of the heat exchanger 110. As shown in FIG. 3, the heat exchanger 110 may include a spiral counterflow heat exchanger. The heater (see 112) and the stack assembly (see 104) are not visible in the view of FIG. 3, and may be disposed within an interior of the heat exchanger 110.

The input gas 114 may include air, and may specifically include air at ambient temperature. The purified oxygen gas 108 is heated by the heat exchanger 110 and the heater 112 and thus comprises an elevated temperature. The purified oxygen gas 108 is not cooled by the heat exchanger 110 and is instead ported out of the COG 102 directly from the stack assembly 104. The oxygen deficient output gas 115 was initially heated by the heat exchanger 110 and the heater 112 prior to being processed by the stack assembly 104; the oxygen deficient output gas 115 was then cooled by the heat exchanger 110 prior to being released to the environment as shown in FIG. 3. Thus, the oxygen deficient output gas 115 may have an elevated temperature relative to the input gas 114, but is cooler than the purified oxygen gas 108.

The purified oxygen gas 108 is output via an output port 302. The output port 302 comprises a hollow tube in fluid communication with the stack assembly 104. The output port 302 may be welded to the tube stub (see 216) of the TPA (see 208). The output port 302 may feed into a storage vessel for the purified oxygen gas 108 and/or may feed directly into a final use-case where the purified oxygen gas 108 is immediately utilized.

The oxygen deficient output gas 115 exits via an output fluid flow path of the heat exchanger 110. The heat exchanger 110 comprising a counterflow heat exchanger including an input fluid flow path that heats the input gas 114, and an output fluid flow path that cools the oxygen deficient output gas 115. The heat exchanger 110 may specifically include a cylindrical spiral heat exchanger as shown in FIG. 3, such that the output fluid flow path comprises an open channel running a length of the longitudinal axis of the heat exchanger 110.

FIGS. 4 and 5 are cross-sectional straight-on end views of assemblies 400, 500 for managing thermal energy for the stack assembly 104 that receives the input gas 114 and outputs each of the oxygen deficient output gas 115 and the purified oxygen gas (see 108, not shown in FIGS. 4-5). The assembly 400 illustrated in FIG. 4 comprises a heat exchanger 401 having a triple spiral counterflow configuration, and the assembly 500 illustrated in FIG. 5 comprises a heat exchanger 504 having a dual spiral counterflow configuration. The COG (see 102) as described herein may include either of the heat exchanger 401 with the triple spiral counterflow configuration, or the heat exchanger 501 with the dual spiral counterflow configuration. In some cases, the COG 102 includes two or more heat exchangers, and the COG 102 may include a combination of the heat exchanger 401 with the triple spiral counterflow configuration and the heat exchanger 501 with the dual spiral counterflow configuration.

Each of the heat exchangers 401, 501 is a spiral heat exchanger comprising a sidewall that defines a hollow cylindrical geometry. The heater 112 and the stack assembly 104 are disposed within the hollow interior of the heat exchanger 401, 501. The hollow cylindrical geometry may comprise a hollow circular cylindrical geometry with a circular cross-section (as shown in at least FIGS. 4 and 5), or may comprise a hollow elliptical cylindrical geometry with an elliptical cross-section or a semi-rectangular cross-section. As described herein, a “cylindrical” geometry includes a circular cylindrical geometry comprising a circular cross-section, an elliptical cylindrical geometry comprising an elliptical cross-section, and/or a semi-rectangular cylindrical geometry comprising a semi-rectangular cross-section.

Each of the heat exchangers 401, 501 receives the input gas 114 into an input fluid flow path 402. The input gas 114 includes any gas comprising oxygen, and may specifically include any gas comprising one or more of oxygen gas, carbon dioxide gas, carbon monoxide gas, water vapor, and so forth. The input gas 114 may be heated or unheated. The input gas 114 may specifically include air at ambient temperature. The input gas 114 is heated by the counterflow heat exchanger 401, 501 prior to being fed through the heater 112 and then passed through the stack assembly 104.

Each of the heat exchangers 401, 501 outputs the oxygen deficient output gas 115 from an output fluid flow path 404. The oxygen deficient output gas 115 is output by the stack assembly 104 and includes components of the input gas 114, minus the purified oxygen gas (see 108) extracted by the stack assembly 104. The oxygen deficient output gas 115 may still comprise any oxygen-containing gas, and may specifically still include one or more of oxygen gas, carbon dioxide gas, carbon monoxide gas, water vapor, and so forth. The oxygen deficient output gas 115 merely comprises less oxygen-containing gases than the input gas 114. The oxygen deficient output gas 115 is cooled by the heat exchanger 401, 501 prior to be released to environment.

Each of the heat exchangers 401, 501 includes a first sheet 408 and a second sheet 410. The triple spiral counterflow heat exchanger 401 additionally includes a third sheet 412. The first sheet 408 comprises a first interior surface facing an interior of the hollow cylindrical geometry, and a first exterior surface facing an exterior of the hollow cylindrical geometry. The second sheet 410 comprises a second interior surface facing the interior of the hollow cylindrical geometry, and a second exterior surface facing the exterior of the hollow cylindrical geometry. The third sheet 412 likewise includes a third interior surface facing the interior of the hollow cylindrical geometry, and a third exterior surface facing the exterior of the hollow cylindrical geometry.

The input fluid flow path 402 (illustrated with cross-hatching) is a negative space disposed in between the first exterior surface of the first sheet 408 and the second interior surface of the second sheet 410. The input gas 114 travels through the input fluid flow path 402 toward the hollow interior of the cylindrical geometry, wherein the input gas 114 will be fed through the heater 112 and the stack assembly. The input gas 114 may be pushed into the input fluid flow path 402 with the blower 106, which may be located externally to the cylindrical geometry of the heat exchanger 401, 501.

In the case of the triple spiral counterflow heat exchanger 401, the output fluid flow path 404 (illustrated without hashing) is a negative space disposed in between the third exterior surface of the third sheet 412 and the first interior surface of the first sheet 408. The triple spiral counterflow heat exchanger 401 additionally includes an insulating fluid flow path 406 (illustrated in FIG. 4 without hashing), which is a negative space disposed in between the second exterior surface of the second sheet 410 and the third interior surface of the third sheet 412. In the case of the dual spiral counterflow heat exchanger 501, the output fluid flow path 404 (illustrated without hashing) is a negative space disposed in between the second exterior surface of the second sheet 410 and the first interior surface of the first sheet 408.

The oxygen deficient output gas 115 travels through the output fluid flow path 404 and exits at a terminal exterior end of the first sheet 408. The oxygen deficient output gas 115 may be very hot when exiting the stack assembly 104, and may specifically be from about 500° C. to about 900° C. The oxygen deficient output gas 115 flows counter the cooler input gas 114, and is thus efficiently cooled by the heat exchanger 401, 501 prior to exiting into the environment.

The insulating fluid flow path 406 included in the triple spiral counterflow heat exchanger 401 is disposed in between the input fluid flow path 402 and the output fluid flow path 404. The insulating fluid flow path 406 further serves to insulate the heater 112 and stack assembly 104, and prevent thermal loss from the interior of the hollow cylindrical geometry. The gas disposed within the insulating fluid flow path 406 is not forced to move in either direction, and is thus substantially stagnant. In some cases, the insulating fluid flow path 406 is partially or fully filled with a refractory insulating material, such as a refractory fibrous material.

Each of the heat exchangers 401, 501 includes an interior wall 414. The interior wall 414 includes two or more openings disposed therethrough. The interior wall 414 includes one or more output openings 416 configured to receive the oxygen deficient output gas 115 output from the stack assembly 104. The one or more output openings 416 enable the oxygen deficient output gas 115 to enter the output fluid flow path 404 and ultimately exit the heat exchanger 401, 501. The one or more output openings 416 may include a channel or other hole running a length of the cylindrical geometry that is substantially equal to a height of the stack assembly 104. In some cases, the output openings 416 include a plurality of holes dispersed over a region similar in height to the stack assembly 104. If the cross-section of the heat exchanger 401, 501 is cut in half through the stack assembly 104, the one or more output openings 416 may be referred to as being located on an “output portion” of the interior of the cylindrical geometry.

The interior wall 414 additionally includes one or more input openings 418 configured to allow the input gas 114 to feed into the hollow interior of the cylindrical geometry. The one or more input openings 418 face the heater 112 such that the input gas 114 passes through the input opening 418 and then enters the heater 112 and the stack assembly 104. The one or more input openings 418 may include a channel or other hole running a length of the cylindrical geometry that is substantially equal to a height of the stack assembly 104. The input openings 418 may include a plurality of holes dispersed over a region similar in height to the stack assembly 104. If the cross-section of the heat exchanger 401, 501 is cut in half through the stack assembly 104, the one or more input openings 418 may be referred to as being located on an “input portion” of the interior of the cylindrical geometry.

As seen in FIGS. 4 and 5, the heat exchangers 401, 501 comprise substantially identical configurations, with the exception of the triple spiral counterflow heat exchanger 401 additionally including the third sheet 412 and the insulating fluid flow path 406. The inclusion of the insulating fluid flow path 406 is not required, but may be utilized to further insulate the thermal energy disposed within the interior of the hollow cylindrical geometry.

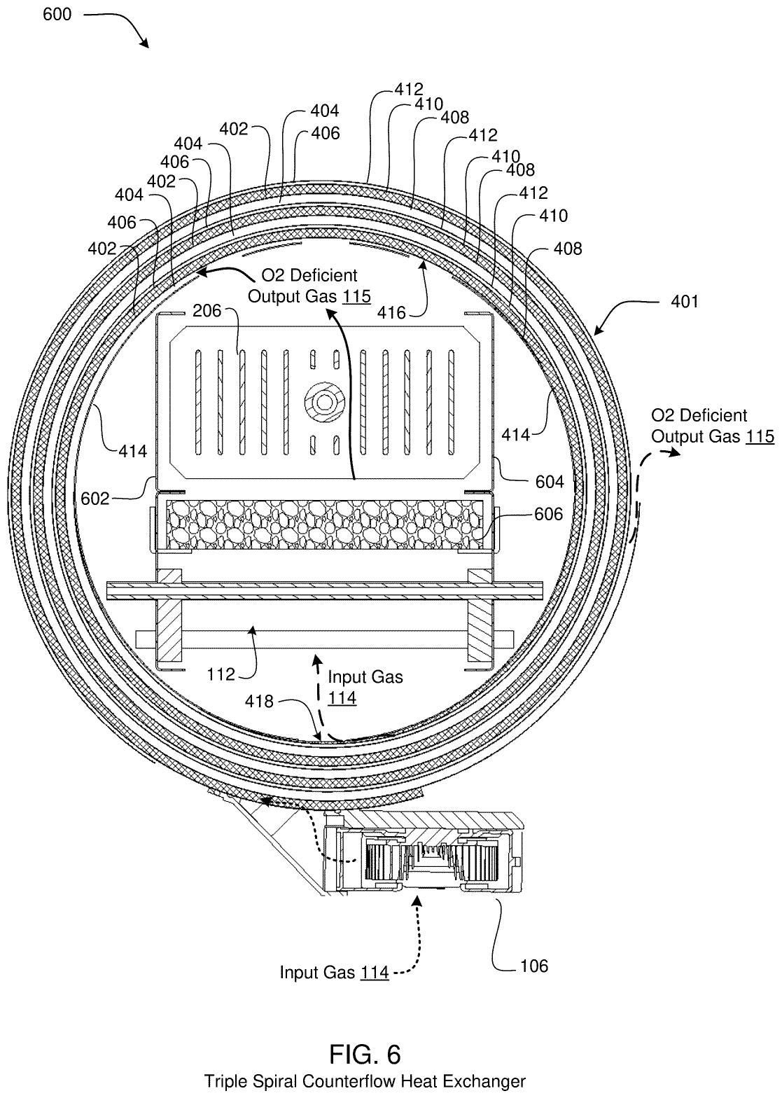

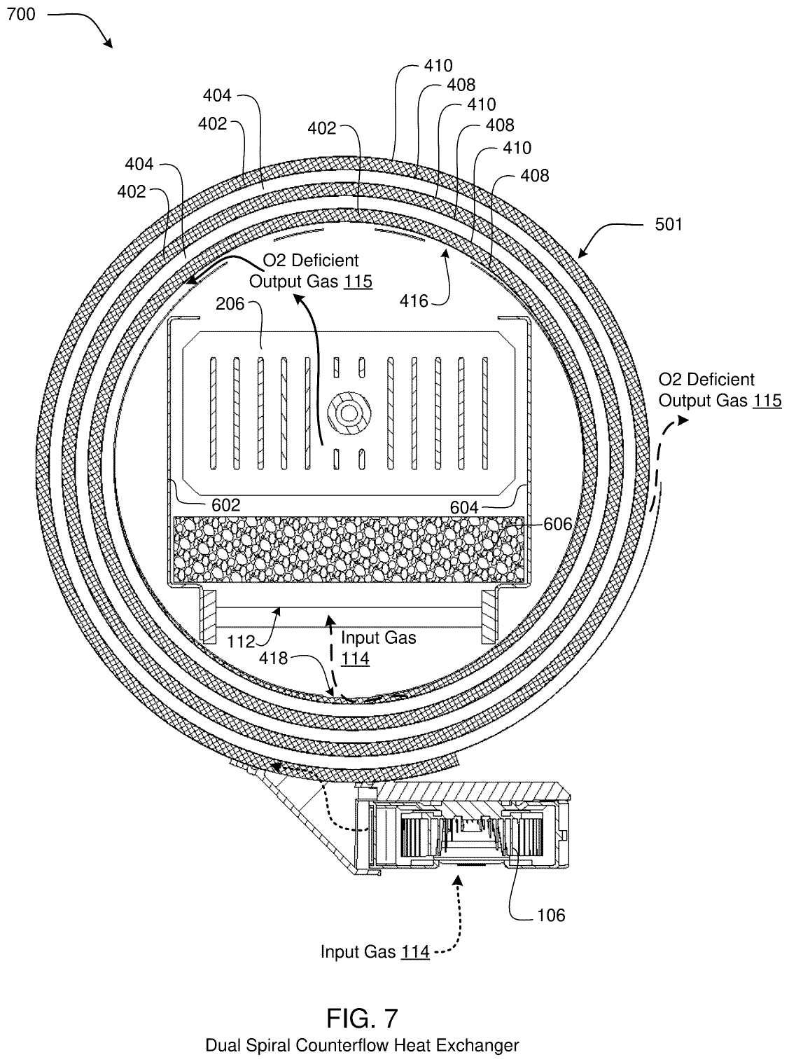

FIGS. 6 and 7 are cross-sectional straight-on end views of COGs 600, 700 that receive the input gas 114 and output each of the oxygen deficient output gas 115 and the purified oxygen gas (see 108, not shown in FIGS. 6-7). The COG 600 illustrated in FIG. 6 includes the triple spiral counterflow heat exchanger 401, and the COG 700 illustrated in FIG. 7 includes the dual spiral counterflow heat exchanger 501. The COGs 600, 700 may be implemented as the COG (see 102) first described in connection with FIG. 1.

The cross-sectional views in FIGS. 6 and 7 slice through the hollow cylindrical geometries of the heat exchangers 401, 501 to reveal a cell 206 of the stack assembly. All portions of the stack assembly (see 104) may be disposed within the hollow cylindrical geometry, including all cells 206, the first and second terminal plates (see 204a, 204b), and the TPA (see 208). The stack assembly is at least partially encased within a housing that comprises a first side plate 602 and a second side plate 604 that is located opposite to the first side plate 602. The heater 112 may be attached to the housing or attached to a secondary structure within the cylindrical space defined by the heat exchanger.

The stack assembly may additionally include a gas diffuser 606 disposed in between the heater 112 and the cells 206 of the electrochemical assembly (see 202). The gas diffuser 606 is constructed of any suitable material capable of diffusing a gas. The gas diffuser 606 receives the input gas 114 that has been heated by the heat exchanger and the heater 112, and then diffuses the input gas 114 to provide uniform gas flow in between the cells 206 of the electrochemical assembly. The gas diffuser 606 may specifically diffuse the input gas 114 to provide a slug flow through the electrochemical assembly.

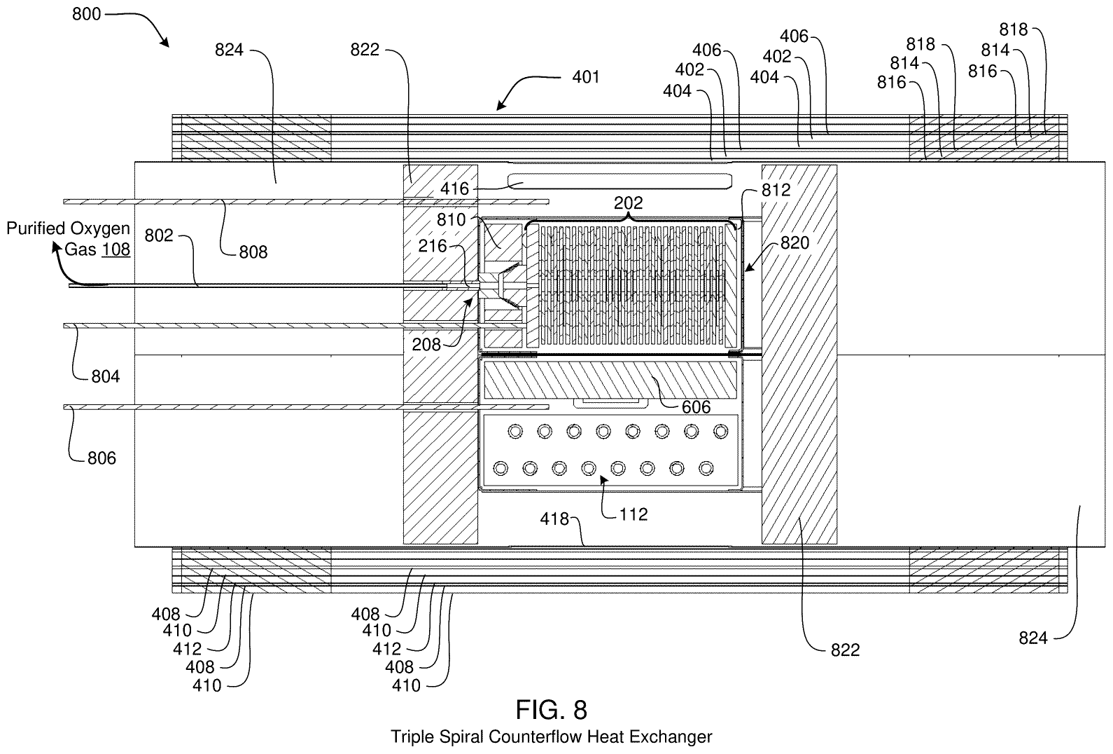

FIG. 8 is a cross-sectional straight-on side view of an assembly 800 for outputting purified oxygen gas 108 with an electrochemical oxygen generator. The assembly 800 includes the triple spiral counterflow heat exchanger 401. The cross-sectional view illustrated in FIG. 8 is sliced longitudinally along a length of the hollow cylindrical geometry of the heat exchanger 401.

The cross-sectional slice illustrated in FIG. 8 enables viewing of the first sheet 408, second sheet 410, and third sheet 412 of the triple spiral counterflow heat exchanger 401. Additionally, the cross-sectional slice enables viewing of an input spacer 814, output spacer 816, and insulating spacer 818 that are disposed in between sheets 408-412 of the heat exchanger 401 to maintain negative space in between adjacent sheets 408-412. The input spacer 814 corresponds with the input fluid flow path 402, and thus maintains the proper negative space in between the first exterior surface of the first sheet 408 and the second interior surface of the second sheet 410. The output spacer 816 corresponds with the output fluid flow path 404, and thus maintains the negative space in between the third exterior surface of the third sheet 412 and the first interior surface of the first sheet 408. The insulating spacer 818 corresponds with the insulating fluid flow path 406, and thus maintains the negative space in between the second exterior surface of the second sheet 410 and the third interior surface of the third sheet 412.

As shown in FIG. 8, the spacers 814-818 do not run an entire longitudinal length of the heat exchanger 401 like the sheets 408-412. The spacers 814-818 instead are located on either side of the negative space of the fluid flow channels 402-406. In the example illustrated in FIG. 8, a first set of spacers 814-818 extends from a top end of the assembly 800 (i.e., the left-hand side of FIG. 8) partially down toward the electrochemical assembly 202 (see hashed regions in between sheets 408-412). Further in the example illustrated in FIG. 8, a second set of spacers 814-818 extends from a bottom end of the assembly 800 (i.e., the right-hand side of FIG. 8) and partially up toward the electrochemical assembly 202. This leaves an open middle space wherein fluid may freely flow through the fluid flow paths 402-406. In an alternative implementation, the assembly 800 includes only one set of spacers 814-818 that is located above or below the electrochemical assembly 202.

The spacers 814-818 prevent the sheets 408-412 from collapsing against each other. The spacers 814-818 resist gas flow. In some cases, the spacers 814-818 may be gas impermeable, and in other cases, the spacers 814-818 may be slightly gas permeable. The spacers 814-818 may be constructed of a compressed mat of refractory fibers that may be referred to as a “refractory fiber felt” or “refractory fiber paper.”. The spacers 814-818 may include a sheet of flexible material. The spacers 814-818 may alternatively or additionally include a plurality of independent spacer materials.

The cross-sectional view in FIG. 8 further enables viewing of a side of the electrochemical assembly 202, including the first and second terminal plates (see 204a-204b at FIG. 2), the plurality of cells (see 206 at FIG. 2), and the TPA 208. As shown, the electrochemical assembly 202 is located adjacent to the gas diffuser 606, and the gas diffuser 606 is adjacent to the heater 112. The assembly 800 further includes a first refractory layer 810 located above the electrochemical assembly 202, and a second refractory layer 812 located below the electrochemical assembly 202. The refractory layers 810, 812 electrically isolate the cells 206 from an electrically conductive housing 820 disposed around the electrochemical assembly 202.

The assembly 800 includes an input thermocouple 806 and an output thermocouple 808. The input thermocouple 806 is a temperature sensor disposed in between the heater 112 and the gas diffuser 606 to measure the temperature of the heated input gas 114. The input thermocouple 806 may be a control thermocouple 806 in communication with a controller that automatically adjusts the thermal energy output of the heater 112 based upon the temperature of the heated input gas 114. The output thermocouple 808 is located near an exit side of the electrochemical assembly 202, wherein oxygen deficient output gas 115 is exiting the electrochemical assembly and about to enter the output fluid flow port 404 of the heat exchanger 401.

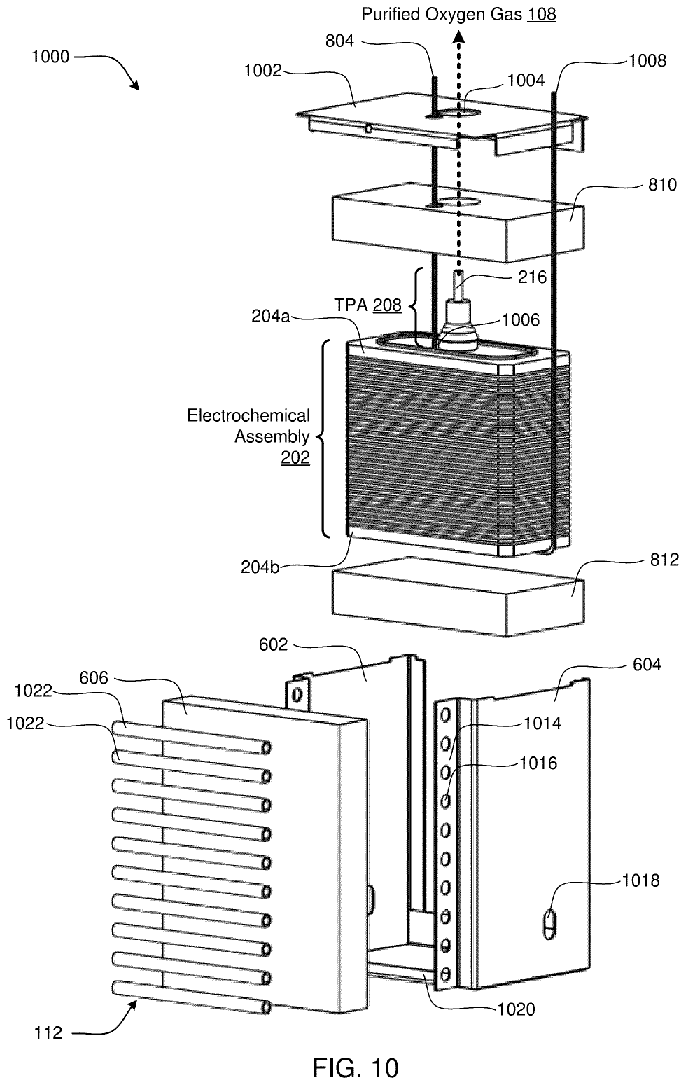

The assembly 800 includes a first electrical lead 804 and additionally includes a second electrical lead (not shown in FIG. 8, see 1008 at FIG. 10). The first electrical lead 804 may connect with the first terminal plate of the electrochemical assembly 202 as shown in FIG. 8. The first electrical lead 804 may alternatively connect with an electrically conductive housing surrounding the electrochemical assembly 202, if the electrochemical assembly 202 is in direct contact with the electrically conductive housing. The electrical lead 804 carries a direct current to power the electrochemical assembly 202 and enable electrolyte membranes within the electrochemical assembly 202 to extract oxygen ions from the input gas 114.

The assembly 800 may additionally include one or more thermal insulation layers 822, 824 located above and below the electrochemical assembly 202 and the housing 820. The thermal insulation layer 822, 824 aid in reducing the loss of thermal energy from the interior of the hollow cylindrical geometry of the heat exchanger 401. In some cases, a proximal thermal insulation layer 816 (i.e., proximal to the electrochemical assembly 202) is manufactured from a rigid refractory thermal insulator material. The distal thermal insulation layer 818 (i.e., distal to the electrochemical assembly 202) may be constructed of a rigid or flexible refractory thermal insulator material.

The input gas 114 is pushed into the input fluid flow path 402 with a blower (see 106), and then the input gas 114 is heated as it winds through the fluid flow path 402, and then the input gas 114 enters the interior of the hollow cylindrical geometry of the heat exchanger 401 via an input opening 418 cut into the interior wall, and then the input gas 114 is heated as it passes through the heater 112, and then the input gas 114 is diffused as it passes through the gas diffuser 606, and then the input gas 114 pass in between cells 206 of the electrochemical assembly 202. The oxygen deficient output gas 115 exits on the opposite side of the electrochemical assembly 202, where it then enters the output fluid flow path 404 via an output opening 416 cut into the interior wall 414. The purified oxygen gas 108 is extracted by the electrochemical assembly 202 and fed through the TPA, into the tube stub 216, and into an output tube 802.

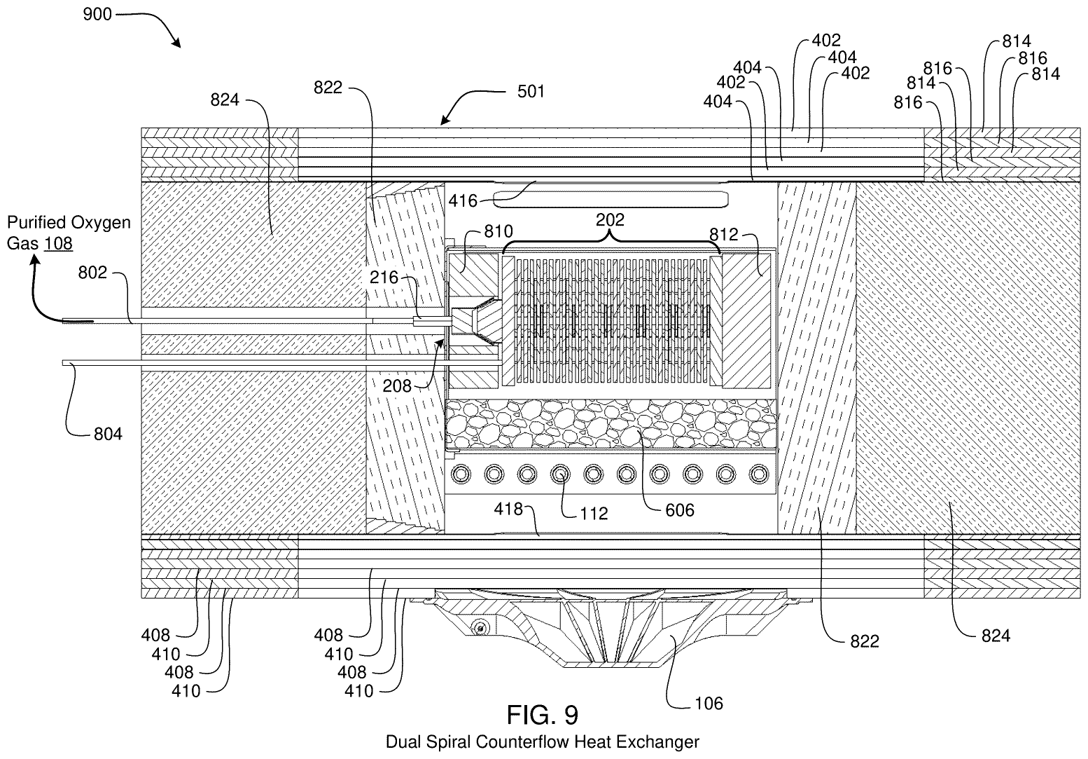

FIG. 9 is a cross-sectional straight-on side view of an assembly 900 for outputting purified oxygen gas 108 with an electrochemical oxygen generator. The assembly 900 includes the dual spiral counterflow heat exchanger 501. The cross-sectional view illustrated in FIG. 9 is sliced longitudinally along a length of the hollow cylindrical geometry of the heat exchanger 501.

The assembly 900 is identical to the assembly 800 described in connection with FIG. 8, but for the heat exchanger including a dual spiral rather than a triple spiral. Notably, FIG. 9 provides a different cross-sectional slice than FIG. 8, and thus, some components visible in FIG. 8 are not visible in FIG. 9, and vice versa.

The cross-sectional view in FIG. 9 enables viewing of the first spacer 814 and the second spacer 816 of the dual spiral counterflow heat exchanger 501. The first spacer 814 maintains the negative space for the first fluid flow path 402, and is thus disposed in between the first exterior surface of the first sheet 408 and the second exterior surface of the second sheet 410. The second spacer 816 maintains the negative space for the second fluid flow path 404, and is thus disposed in between the second exterior surface of the second sheet 410 and the first interior surface of the first sheet 408. The spacers 814, 816 may be located on both ends of the first and second fluid flow paths 402, 404 as shown in FIG. 9 (i.e., the spacers 814, 816 are located on each of the left-hand side and the right-hand side of the fluid flow paths 402, 404 in the view of FIG. 8). Alternatively, the spacers 814, 816 may be located on only one of the ends of the first and second fluid flow paths 402, 404 (i.e., the spacers 814, 816 may be located on only one of the left-hand side or the right-hand side of the fluid flow paths 402, 404 based upon the view in FIG. 9).

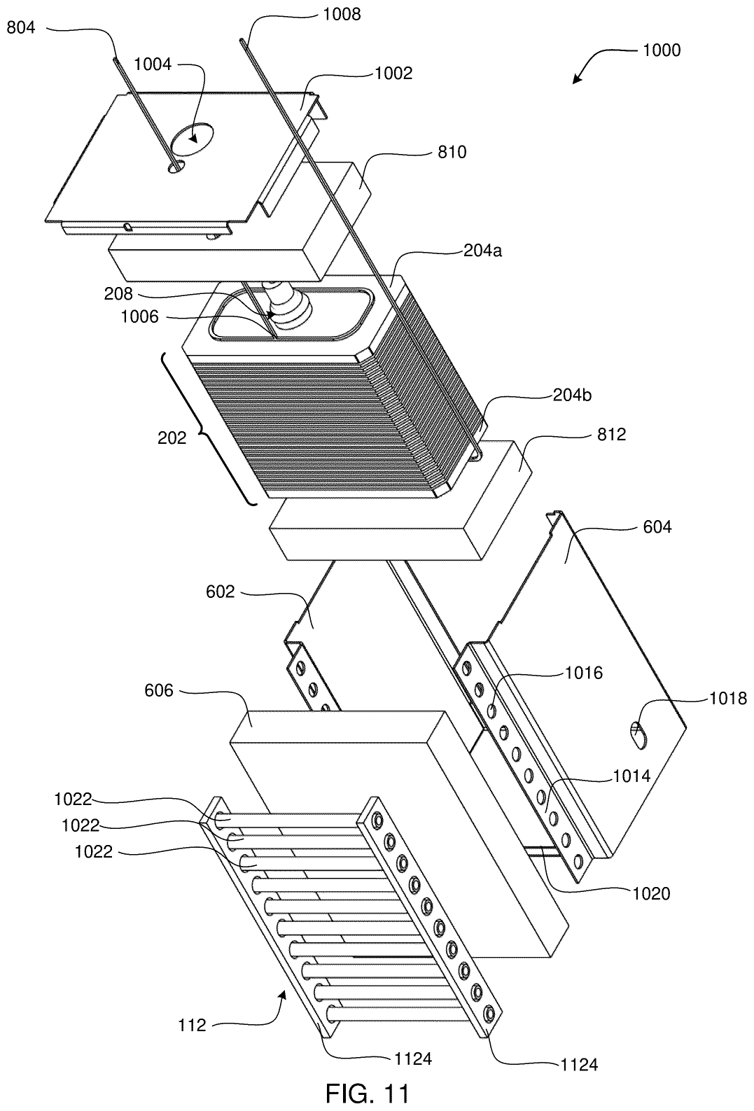

FIGS. 10 and 11 are exploded perspective views of an assembly 1000 for housing an electrochemical assembly 202. The assembly 1000 protects the delicate ceramic cells of the electrochemical assembly 202 from mechanical damage. Additionally, the assembly 1000 includes components for applying a compressive force to the electrochemical assembly 202 to ensure electrical lead wires maintain contact with the electrochemical assembly 202 to energize the electrochemical assembly 202.

The assembly 1000 includes a housing comprising six sides, wherein at least one of the six sides of the housing is open to permit gas flow in between the cells (see 206) of the electrochemical assembly 202. As described herein, the housing may be referred to as an “open” housing because the electrochemical assembly 202 is not entirely enclosed on all six sides, but gas flow is permitted through the open housing and through the electrochemical assembly 202.

The assembly 1000 includes a top plate 1002 configured to be placed above the electrochemical assembly 202 relative to the direction of flow of the purified oxygen gas 108 (wherein the direction of flow of purified oxygen gas 108 points in the “upward” direction). The assembly 1000 further includes a bottom plate 1020 configured to be placed underneath the electrochemical assembly 202 relative to the direction of flow of the purified oxygen gas 108. One or more of the top plate 1002 or the bottom plate 1020 may comprise a perpendicular bend (may be referred to as a “tab”) that forms a portion of an open side of the housing.

The top plate 1002 includes a plumbing hole 1004 disposed therethrough. The plumbing hole 1004 is configured to receive one or more components of the TPA 208, and is specifically configured to receive the tube stub 216 of the TPA 208, which will ultimately feed into the output tube (not pictured, see 802). The top plate 1002 may additionally include an electrical lead wire hole configured to receive the first electrical lead 804. The first electrical lead 804 extends through the top plate and the top refractory layer 810 to then contact the first terminal plate 204a of the electrochemical assembly 202.

The assembly 1000 further includes a first side plate 602 and a second side plate 604 positioned on opposing sides of the electrochemical assembly 202. One or more of the first side plate 602 or the second side plate 604 may include a perpendicular bend or “tab” that forms a portion of an open side of the housing.

The plates 1002, 1020, 602, 604 of the housing may be constructed of an electrically conductive material, and may specifically be constructed of a metal material. The plates 1002, 1020, 602, 604 may be constructed of one or more of 300 series stainless steel, 400 series stainless steel, any high temperature oxidation resistant nickel-based alloy, any high temperature oxidation resistant iron-nickel-chrome based alloy, any high temperature oxidation resistant iron-chrome-aluminum based alloy, any high temperature oxidation resistant molybdenum based alloy including substantially pure molybdenum, any high temperature oxidation resistant tungsten based alloy including substantially pure tungsten, or any high temperature oxidation resistant metal alloy.

The assembly 1000 includes the top refractory layer 810, which is placed above the electrochemical assembly 202 relative to the direction of flow of the purified oxygen gas 108. The assembly 1000 includes a bottom refractory layer 812, which is placed below the electrochemical assembly 202 relative to the direction of flow of the purified oxygen gas 108. Each of the refractory layers 810, 812 electrically isolates the electrochemical assembly 202 from the electrically conductive components of the housing and/or electrically conductive components of the surrounding heat exchanger. The first electrical lead 804 passes through the top refractory layer 810 to contact the first terminal plate 204a of the electrochemical assembly.

The refractory layers 810, 812 are electrically insulating and serve to electrically isolate the electrochemical assembly 202 from the electrical leads 804, 1008. The refractory layers 810, 812 may be constructed from a compressible refractory fibrous mat or woven material. The refractory layers 810, 812 may be constructed of a soft conforming material that later transforms into a rigid material after drying or curing. The refractory layers 810, 812 may be constructed of a fibrous ceramic material.

The assembly 1000 includes the gas diffuser 606, which is disposed in between the electrochemical assembly 202 and the heater 112. The gas diffuser may include a ceramic reticulated foam configured to receive the heated input gas 114 and cause the input gas to flow through the electrochemical assembly 202 with a slug flow.

The heater 112 includes one or more heating elements 1022 that may run substantially parallel to a planar surface of the cells (see 206) of the electrochemical assembly 202. In some cases, the first and second side plates 602, 604 include a heater support band 1014 that comprises a plurality of heating element holes 1016 configured to receive and support the heating elements 1022.

The assembly 1000 includes the first electrical lead 804 and additionally includes a second electrical lead 1008. In the example illustrated in FIGS. 10-11, the second electrical lead 1008 extends from the top plate 1002 to the second terminal plate 204b of the electrochemical assembly 202. The second electrical lead 1008 travels on an exterior side of the second side plate 604 and passes through the second side plate 604 through an electrical lead hole 1018 formed through the second side plate 604. In this example, the first electrical lead 804 contacts the first terminal plate 204a, and the second electrical lead 1008 contacts the second terminal plate 204b. The electrical leads 804, 1008 are responsible for energizing the electrochemical assembly 202 and enabling electrolyte membranes within the electrochemical assembly 202 to isolate oxygen ions and generate the purified oxygen gas 108.

The assembly 1000 may include a paste 1006 that is electrically conductive and serves to reduce electrical interference between an electrical lead 804, 1008 and a terminal plate 204a, 204b. The paste 1006 may be applied in between an electrical lead 804, 1008 and a terminal plate 204a, 204b. In the example illustrated in FIG. 10, the paste 1006 may be applied in between the first electrical lead 804 and the first terminal plate 204a, and the paste 1006 may further be applied in between the second electrical lead 1008 and the second terminal plate 204b.

The paste 1006 may comprise one or more of silver, gold, platinum, palladium, rhodium, ruthenium, rhenium, iridium, chromium, manganese, iron, cobalt, nickel, copper, zinc, magnesium, sodium, potassium, calcium, hafnium, tantalum, tungsten, thallium, indium, tin, lead, or bismuth. The paste 1006 may be partially or fully sintered. The paste 1006 may comprise a metal oxide powder, and specifically may include a metal oxide powder selected from any of the second, third, fourth, fifth, or sixth rows of the periodic table.

As shown in FIG. 11, the heater 112 may include two heater support beams 1124 comprising a plurality of holes disposed therethrough for receiving the plurality of heating elements 1022. The heater support beams 1124 may be coupled to the heater support bands 1014 of the first and second side plates 602, 604.

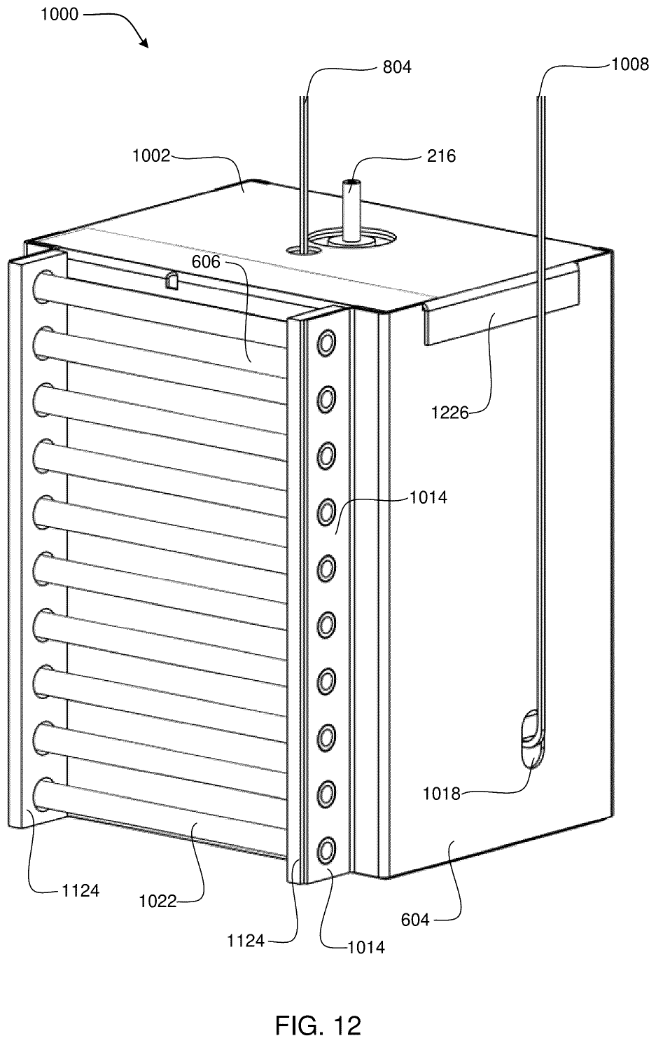

FIG. 12 is a perspective view of the assembly 1000 for housing an electrochemical assembly 202. The electrochemical assembly 202 is disposed within the open housing, and is thus not visible in the view of FIG. 12.

As shown in FIG. 12, the top plate 1002 may include a perpendicular tab 1226 that attaches to the second side plate 604. The perpendicular tab 1226 is oriented substantially perpendicular to the surface of the top plate 1002. The top plate 1002 may additionally include other perpendicular tabs that are not visible in FIG. 12.

Further as shown in FIG. 12, the second electrical lead 1008 runs down an exterior surface of the second side plate 604, and then enters the interior of the housing via the electrical lead hole 1018. The second electrical lead 1008 may then contact the second terminal plate 204b of the electrochemical assembly 202.

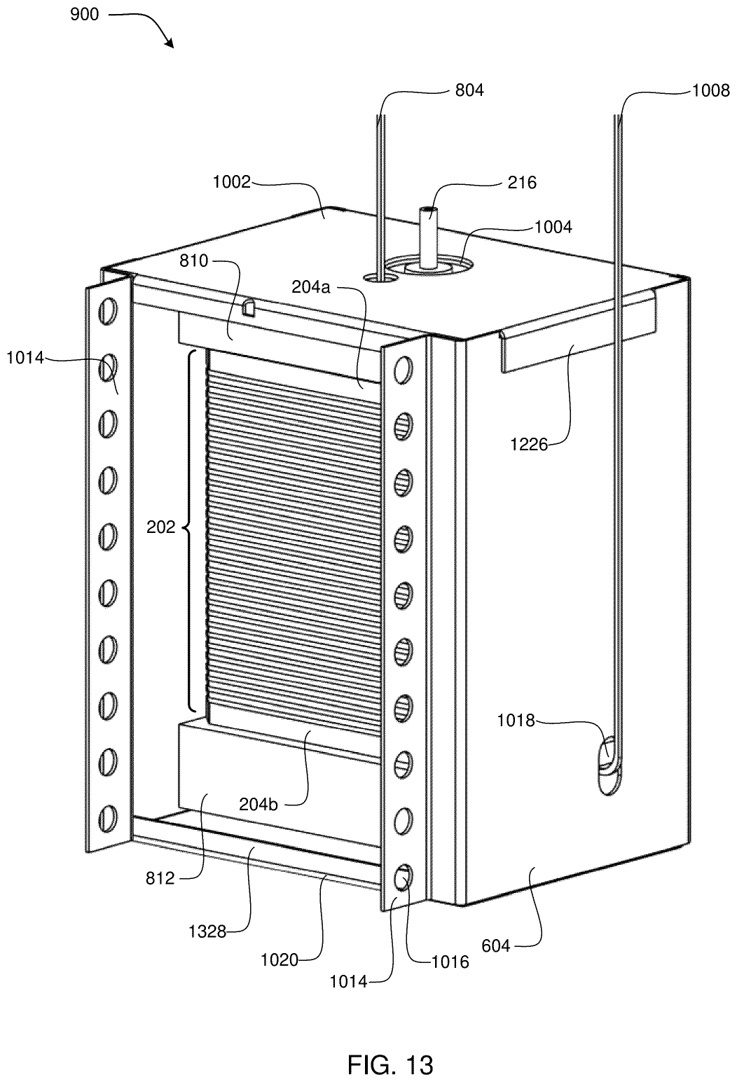

FIG. 13 is a perspective view of the assembly 1000 for housing an electrochemical assembly, and specifically illustrates an “input” side of the assembly 1000, which is the side that receives the input gas 114 prior to the input gas 114 being processed through the electrochemical assembly 202. In the view of FIG. 13, the gas diffuser 606 and heating elements 1022 have been removed to reveal the electrochemical assembly 202 disposed within the interior of the housing. As shown in FIG. 13, the bottom plate 1020 may include an input perpendicular tab 1328 that is oriented substantially perpendicular to the planar surface of the bottom plate 1020 on the input side of the assembly 1000. The input perpendicular tab 1328 may be utilized to support the gas diffuser 606 and/or attach the housing to the gas diffuser 606.

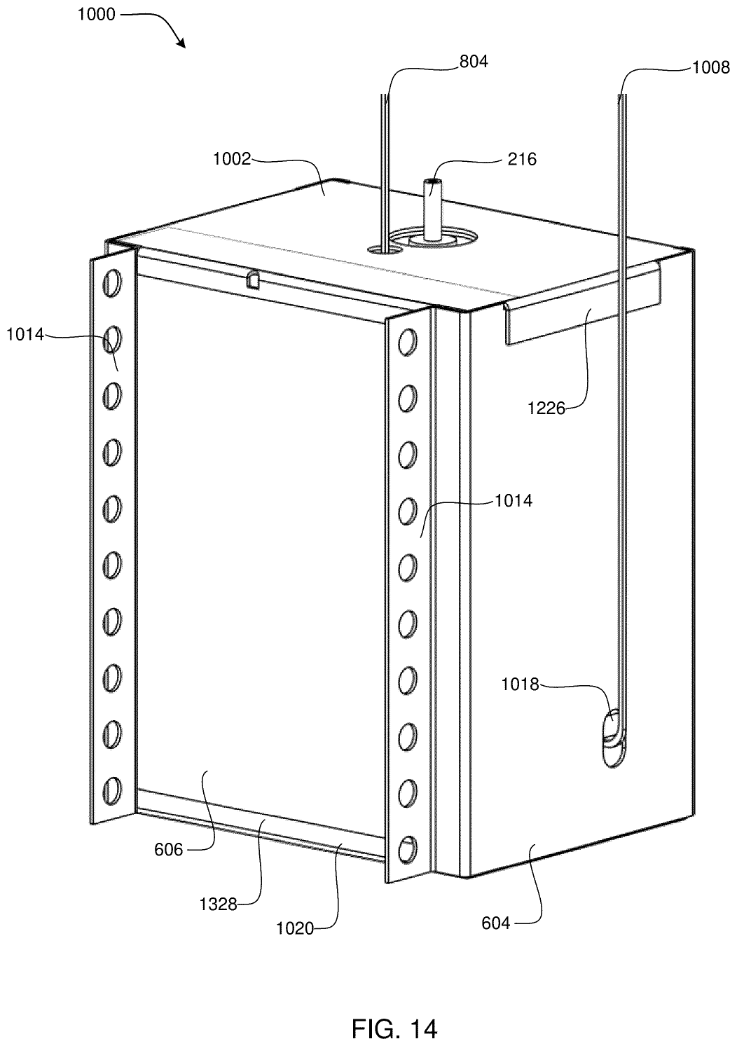

FIG. 14 is a perspective view of the assembly 1000 for housing an electrochemical assembly, and specifically illustrates the input side of the assembly 1000. In the view shown in FIG. 14, the heating elements 1022 have been removed to reveal the gas diffuser 606. The input side of the electrochemical assembly 202 is an open side even when the gas diffuser 606 and heater 112 are installed, because gas is permitted to pass through the input side and enter the electrochemical assembly 202.

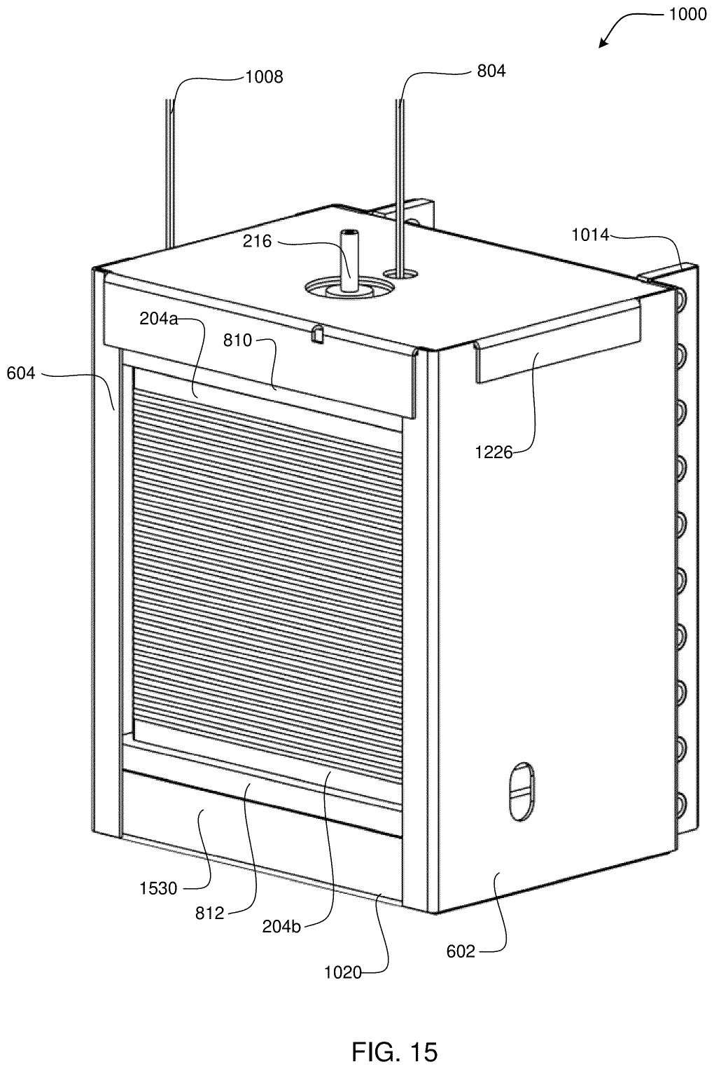

FIG. 15 is a perspective view of the assembly 1000 for housing an electrochemical assembly, and specifically illustrates an “output” side of the assembly 1000, which is the side that outputs the oxygen deficient output gas 115 that has been processed through the electrochemical assembly 202. As shown in FIG. 15, the bottom plate 1020 may include an output perpendicular tab 1530 that is oriented substantially perpendicular to the planar surface of the bottom plate 1020 on the output side of the assembly 1000. The output perpendicular tab 1530 may be utilized to support the bottom refractory layer 812 and/or attach the housing to the bottom refractory layer 812.

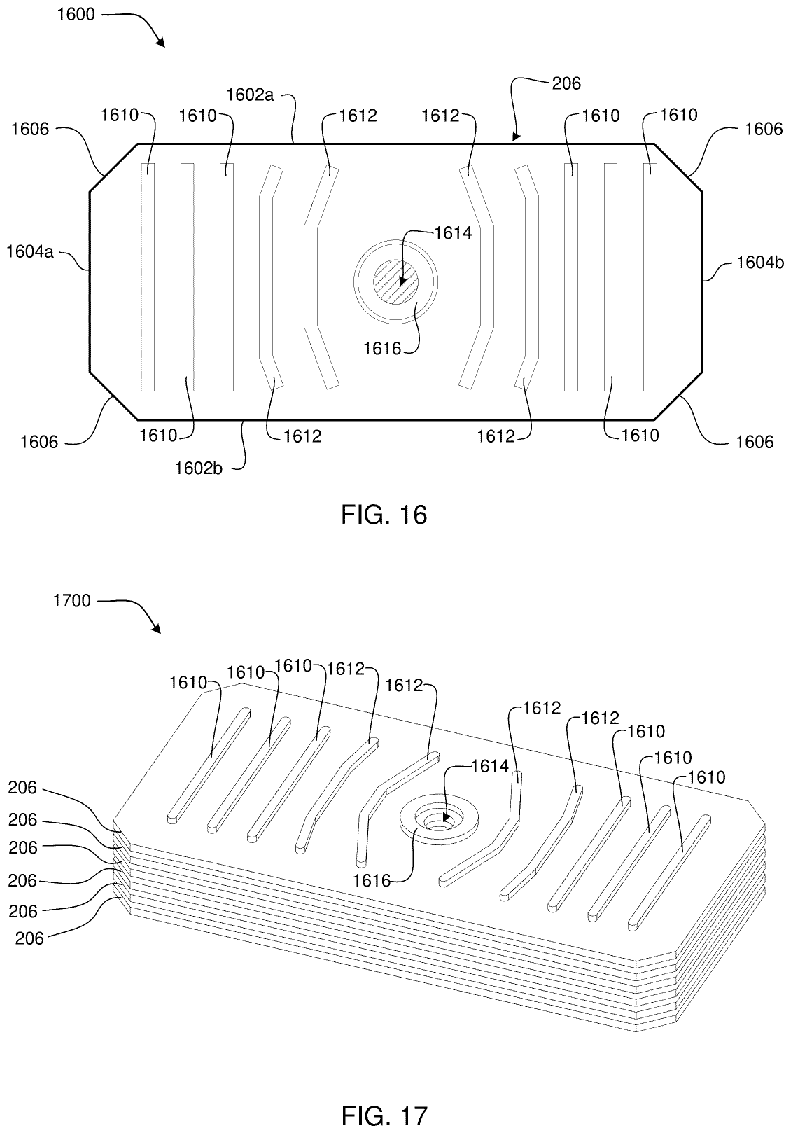

FIG. 16 is a schematic illustration of an aerial top-down view of a cell assembly 1600. The cell assembly 1600 includes a cell 206, spacer 1616, and a plurality of interconnects 1610, 1612 attached to a surface of the cell 206.

The cell 206 may include a quadrilateral planar geometry as shown in FIG. 16. The quadrilateral geometry may include two longer sides 1602a, 1602b and two shorter sides 1604a, 1604b. The quadrilateral geometry may further include one or more chamfered corners 1606 as shown in FIG. 16.

The cell assembly 1600 includes interconnects 1610, 1612 formed on the top surface of the cell 206. The interconnects 1610, 1612 serve to provide electrochemical communication between adjacent cells 206 within an electrochemical assembly (see 202). The interconnects 1610, 1612 may be referred to as “ribs” as they run across a width of an upper face of the cell 206, as shown in the FIG. 16. The interconnects 1610, 1612 are constructed of a material comprising high electrical conductivity and low electrical resistance. When a voltage is applied to the electrochemical assembly (see 202), the interconnects 1610, 1612 serve as a current carrier between adjacent cells 206. The interconnects 1610, 1612 may comprise from about 5 vol. % to about 95 vol. % an electrically conductive material, and may specifically comprise from about 30 vol. % to about 70 vol. % the electrically conductive material. The interconnects 1610, 1612 may further comprise from about 20 vol. % to about 90 vol. % a partially or wholly sintered ceramic powder. The interconnects 1610, 1612 may further comprise from about 0.25 wt. % to about 5 wt. % a sintering aid that lowers a sintering temperature of the interconnects, wherein the sintering aid may include one or more of cobalt, copper, nickel, manganese, or iron.

The interconnects 1610, 1612 comprise high mechanical strength and attachability. When the electrochemical assembly (see 202) is operating, a high flow rate of input gas (see 114) is passing in between adjacent cells 206, so the interconnects 1610, 1612 must have sufficient mechanical strength to ensure integrity is not harmed during operation. The interconnects 1610, 1612 have high dimensional stability to ensure the interconnects 1610, 1612 maintain physical contact between adjacent cells 206 to enable electrical contact between cells 206.

The interconnects 1610, 1612 are porous to ensure oxygen containing molecules can diffuse through the interconnects 1610, 1612 and electrochemically react with the functional layers of the cells 206.

The interconnects 1610, 1612 may comprise a portion of straight line interconnects 1610 and bent line interconnects 1612 as shown in FIG. 16. The bent line interconnects 1612 may comprise one or more angle vertexes to enable the bent line interconnect 1612 to wrap around the spacer 1616 and oxygen delivery hole 1614. The bent line interconnects 1612 may specifically include two angle vertexes or curves as shown in FIG. 16, such that the bent line interconnects 1612 comprise a middle parallel portion running parallel to an edge of the cell 206, and further comprise two or more non-parallel portions that do not run parallel to an edge of the cell 206.

FIG. 17 is a perspective view of a cell stack 1700 comprising six cells 206. One or more cell stacks 1700 may be included in the electrochemical assembly (see 202) of the stack assembly (see 104). The exemplary cell stack 1700 illustrated in FIG. 17 includes six cell-spacer assemblies (see 1000), although only the topmost cell-spacer assembly is visible in the view of FIG. 17.

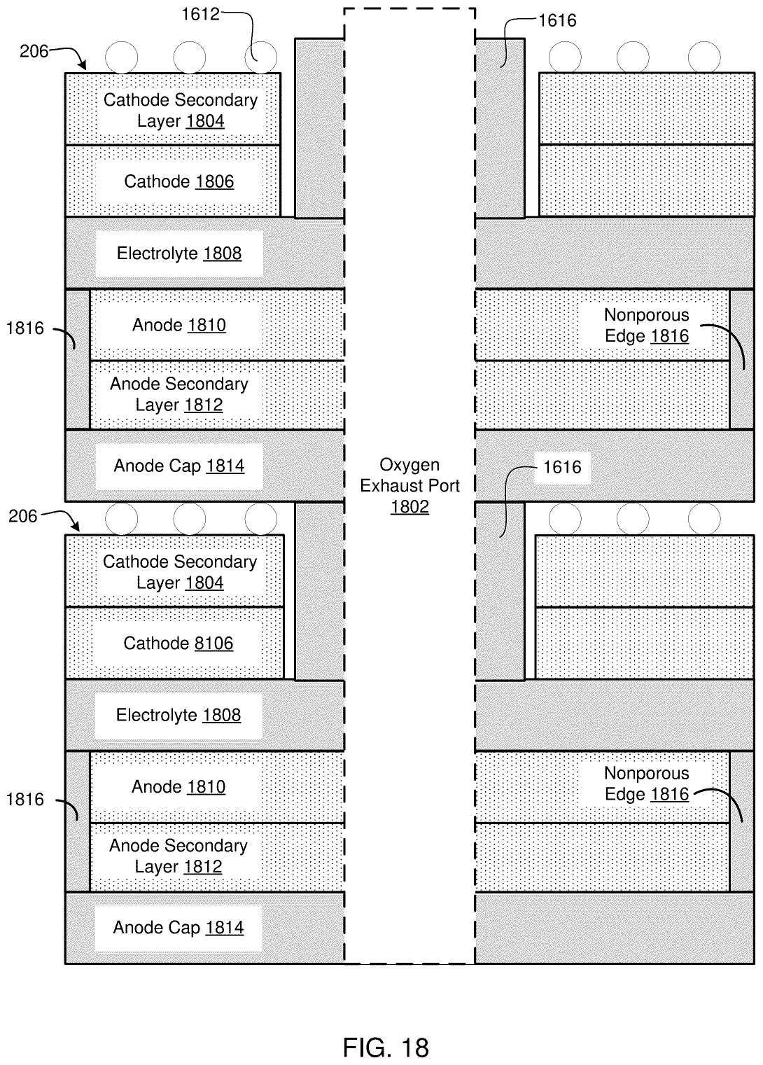

FIG. 18 is a schematic illustration of a cross-sectional straight-on side view of two adjacent cells 206 of an electrochemical assembly (see 202) of a stack assembly (see 104). The cells 206 serve as a ceramic ion transport membrane that extracts oxygen from an input gas 114 and then transports the oxygen across an impermeable, dense, monolithic ceramic structure.

Each cell 206 includes a cathode, electrolyte 1808, and anode. The cells 206 specifically include a cathode secondary layer 1804, cathode 1806, electrolyte 1808, anode 1810, anode secondary layer 1812, and anode cap 1814. The cells 206 includes a nonporous edge 1816 that extends from the electrolyte 1808 to the anode cap 1814 to seal the porous anode 1810 and porous anode secondary layer 1812. The cells 206 include the spacer 1616, which is sealed to the electrolyte 1808 and extends upward to seal the porous cathode 1806 and porous cathode secondary layer 1804. As shown in FIG. 18, the spacer 1616 extends above the surface of the cathode secondary layer 1804 and is sealed to the anode cap 1814 of an adjacent cell 206.

The spacer 1616 provides a gap between two cells 206 in the electrochemical assembly 202. The gap enables the input gas 114 to enter at the leading edge of a cell 206 and further enables the oxygen deficient output gas 115 to exit at the trailing edge of the cell 206. The spacer 1616 surrounds an oxygen exhaust port 1802 that provides an outlet for purified oxygen gas 108 to exit the stack assembly (see 104).

There are numerous benefits to the spacer 1616 being co-sintered with the remaining layers of the cell 206. The spacer 1616 provides a gastight seal with the anode cap 1814 of an adjacent cell 206 located above the spacer 1616, and the spacer 1616 further provides a gastight seal with the electrolyte 1808 of the same cell 206. When the spacer 1616 is co-sintered with the other layers of the cell 206, the gastight seal between the spacer 1616 and the electrolyte 1808 is structurally more rigid and provides an improved nonporous seal. There are numerous challenges associated with co-sintering the spacer 1616 with the other layers of the cell 206. One such challenge is the sintering process may cause the spacer 1616 to curl and separate from the remaining layers due to differences in thickness, shape, and materials.

The cathode secondary layer 1804 is a porous material and is configured to receive the input gas 114. The input gas 114 is passed over the electrochemical assembly 202 and over each cell 206 within the electrochemical assembly 202. The input gas 114 may be blown into the electrochemical assembly 202. Molecular diffusion causes the input gas 114 to enter the cathode secondary layer 1804. The cathode 1806 is a porous material and is configured to receive the input gas 114 after the input gas 114 has passed through the cathode secondary layer 1804. Molecular diffusion causes the input gas 114 to enter the cathode 1806. The cathode 1806 makes direct contact with the electrolyte 1808.

The electrolyte 1808 is a specialized ceramic material that receives oxygen ions. The electrolyte 1808 is nonporous when compared with the cathode secondary layer 1804, cathode 1806, anode 1810, or anode secondary layer 1812. The electrolyte 1808 may be referred to as “nonporous,” but it should be appreciated the electrolyte 1808 may still have some unavoidable porosity due to its inherent ceramic properties. The electrolyte 1808 may specifically be described as having no through-porosity such that the electrolyte 1808 does not permit molecular diffusion across the electrolyte 1808 layer but will permit diffusion of oxygen ions across the electrolyte 1808 layer. There are oxygen atom deficiencies throughout the crystal structure of the electrolyte 1808. The electrolyte 1808 will not permit diffusion of ions other than oxygen ions (O²⁻). The input gas 114 located within the cathode 1806 may include oxygen molecules (O₂). A voltage is applied to the electrochemical assembly 202 that enables a reduction reaction to occur to the oxygen molecules (O₂) at the surface of the electrolyte 1808. The reduction reaction follows Equation 1, below.

$${O}_{2} + 4 {e}^{-} \to 2 {O}^{2 -} \qquad Equation 1$$

The reduction of the oxygen molecules (see Equation 1) occurs at the surface of the electrolyte 1808, and it may also occur in the cathode 1806 in close proximity to the electrolyte 1808. The reduction of one oxygen molecule results in two oxygen ions. The two oxygen ions are accepted by the electrolyte 1808 to fill oxygen deficiencies within the crystal lattice structure of the electrolyte 1808 ceramic material. Oxygen ions travel within the crystal lattice structure of the electrolyte 1808, and possibly along grain boundaries of electrolyte 1808, and are eventually oxidized at the surface of the anode 1810 according to Equation 2, below.

$$2 {O}^{2 -} \to {O}_{2} + 4 {e}^{-} \qquad Equation 2$$

The anode 1810 is a porous material that accepts the oxygen molecules (O₂). During operation, a voltage, or EMF is applied to the electrochemical assembly 202. Because of the EMF, the oxygen molecules created according to Equation 2 near the anode-side of the electrolyte 1808 may be consumed by the anode 1810 even when the oxygen molecules are travelling from the electrolyte 1808 to the anode 1810 against a concentration gradient. Because the electrolyte 1808 lacks through-porosity and will only accept oxygen ions, the anode 1810 and anode secondary layer 1812 may only consume pure oxygen. The electrolyte 1808 is such that there are no non-oxygen molecules or ions traveling through the electrolyte 1808 crystal lattice structure that may eventually reach the surface of the anode 1810. The anode secondary layer 1812 is a porous material that holds the purified oxygen gas 108 that is received by the anode 1810.

The anode cap 1814 is a nonporous material that prevents the purified oxygen gas 108 from traveling beyond the anode secondary layer 1812. There is a hole running through each of the layers of the cell 206 such that the purified oxygen gas 108 may only travel through the oxygen exhaust port 1802 and be harvested by the system.

The spacer 1616 extends to the electrolyte 1808 to prevent contamination of the purified oxygen gas 108 that is traveling in the oxygen exhaust port 1802. The spacer 1616 is nonporous and does not permit any molecules or ions to pass through. The cathode secondary layer 1804 and the cathode 1806 each consume input gas 114 that includes oxygen along with other contaminants such as nitrogen, argon, and other particles. The nonporous spacer 1616 prevents the other contaminants from exiting the cathode secondary layer 1804 and/or the cathode 1806 and then ultimately entering the oxygen exhaust port 1802. The oxygen exhaust port 1802 only includes purified oxygen gas 108.

The anode cap 1814 is nonporous and provides a barrier similar to that provided by the spacer 1616. The anode cap 1814 prevents contaminants, such as nitrogen, argon, or other particles, from entering the oxygen exhaust port 1802. Further, the anode cap 1814 prevents the purified oxygen gas 108 that is located within the anode 1810 and/or the anode secondary layer 1812 from exiting the system and reentering the atmosphere. The purified oxygen gas 108 is located within the anode 1810 and the anode secondary layer 1812. The interior edges (i.e., the edge along the oxygen exhaust port 1802) of the anode 1810 and/or the anode secondary layer 1812 are open such that the purified oxygen gas 108 may exit and enter the oxygen exhaust port 1802. The purified oxygen gas 108 exits the system by way of the oxygen exhaust port 1802 where it may eventually be used on-site or harvested in a tank or other vessel.

Each of the anode 1810 and the anode secondary layer 1812 includes a nonporous edge 1816. The nonporous edge 1816 surrounds the perimeter of the anode 1810 and the anode secondary layer 1812. The nonporous edge 1816 prevents the purified oxygen gas 108 from exiting either of the anode 1810 and/or the anode secondary layer 1812 and reentering the atmosphere. The nonporous edge 1816, along with the electrolyte 1808 and the anode cap 1814, forces the purified oxygen gas 108 to exit the system by way of the oxygen exhaust port 1802.

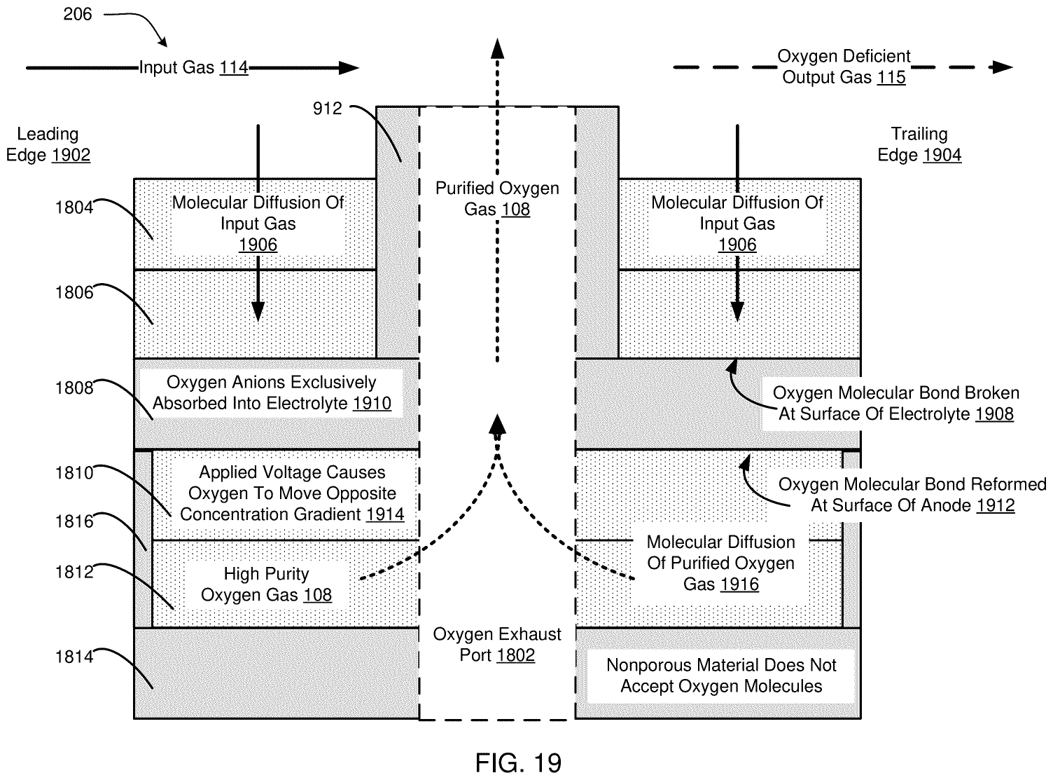

FIG. 19 is a schematic diagram of a cross-sectional view of the cell 206 further depicting the pathways of the input gas 114, oxygen deficient output gas 115, oxygen gas, oxygen ions, and oxygen molecules. The cell 206 includes a leading edge 1902 and a trailing edge 1904. The input gas 114 passes over the cell 206 starting with the leading edge 1902 and ending with the trailing edge 1904. The input gas 114 may pass over the cell 206 beginning with the leading edge 1902. Input gas 114 enters the cell 206 at the cathode secondary layer 1804. Molecular diffusion causes the input gas 114 to pass into the porous cathode secondary layer 1804 at 1906 until it reaches electrolyte 1808. Molecular diffusion causes the molecules of the input gas 114 to travel through the cathode secondary layer 1804 and the cathode 1806. The spacer 1616 prevents the molecules of the input gas 114 from entering the oxygen exhaust port 1802.

The oxygen molecules are reduced (see Equation 1) near the surface and at the surface of the electrolyte 1808 where the oxygen molecular bond is broken at 1908. The crystal structure of the electrolyte 1808 has oxygen deficiencies and causes the oxygen ions to travel through the electrolyte 1808. The electrolyte 1808 exclusively accepts oxygen ions at 1910. At the opposite end of the electrolyte 1808 at the surface of the anode 1810, the oxygen ions are oxidized (see Equation 2) and the oxygen molecular bond is reformed at 1912. A voltage or EMF is applied to the electrochemical assembly 202 and this EMF causes the oxygen molecules to form near the surface of the anode 1810 as shown at 1912, even if there exists a high concentration of oxygen molecules in the anode 1810 and the anode secondary layer 1812. The anode 1810 and the anode secondary layer 1812 include only purified oxygen gas 108. The nonporous anode cap 1814 prevents the purified oxygen gas 108 from exiting the system and reentering the atmosphere at 1918. Molecular diffusion causes the purified oxygen gas 108 to leave the anode 1810 and/or the anode secondary layer 1812 to enter the oxygen exhaust port 1802 at 1916. The nonporous edge 1816 prevents the purified oxygen gas 108 from exiting the anode 1810 and/or the anode secondary layer 1812 and reentering the environment. The purified oxygen gas 108 may travel the length of the electrochemical assembly 202 up the oxygen exhaust port 1802 where it may eventually be used on-site or harvested in a tank or other vessel.

As the system is operating, the purified oxygen gas 108 within the anode 1810 and/or the anode secondary layer 1812 builds pressure. Further, the input gas 114 within the cathode 404 and/or the cathode secondary layer 406 exists at one atmosphere of pressure when operating at sea level at ambient conditions. In an instance where the input gas 114 is air, the input gas 114 includes approximately 21% oxygen. In this instance, where purified oxygen gas 108 exists at some pressure within the anode and gas comprising 21% oxygen exists within the cathode at one atmosphere of pressure, the concentration gradient would push oxygen gas to the cathode where there is less concentration of oxygen. However, the voltage applied to the system causes the oxygen to move opposite the concentration gradient to exit the electrolyte 460 and enter the anode at 1914.

### Examples

The following examples pertain to further embodiments.

Example 1 is an assembly. The assembly includes a counterflow heat exchanger comprising a sidewall that defines a hollow cylindrical geometry. The assembly includes an electrochemical assembly comprising a plurality of ceramic cells, wherein the electrochemical assembly is disposed within an interior of the hollow cylindrical geometry of the counterflow heat exchanger. The assembly is such that the electrochemical assembly receives an input gas comprising oxygen that is heated when passing through an input fluid flow path of the counterflow heat exchanger. The assembly is such that the electrochemical assembly outputs an oxygen-deficient output gas that is cooled when passing through an output fluid flow path of the counterflow heat exchanger.

Example 2 is an assembly as in Example 1, wherein the counterflow heat exchanger comprises one of a dual spiral counterflow heat exchanger or a triple spiral counterflow heat exchanger.

Example 3 is an assembly as in any of Examples 1-2, wherein the sidewall of the counterflow heat exchanger is formed by at least: a first sheet formed into a first spiral, wherein the first sheet comprises a first interior surface and a first exterior surface; a second sheet formed into a second spiral, wherein the second sheet comprises a second interior surface and a second exterior surface; wherein the input fluid flow path is disposed in between the first exterior surface of the first sheet and the second interior surface of the second sheet; and wherein the output fluid flow path is disposed adjacent to the first interior surface of the first sheet.

Example 4 is an assembly as in any of Examples 1-3, wherein the sidewall of the counterflow heat exchanger further comprises a third sheet formed into a third spiral, wherein the third sheet comprises a third interior surface and a third exterior surface; wherein the output fluid flow path is disposed in between the third exterior surface of the third sheet and the first interior surface of the first sheet; and wherein an insulating fluid flow path is disposed in between second exterior surface of the second sheet and the third interior surface of the third sheet.

Example 5 is an assembly as in any of Examples 1-4, wherein each of the input fluid flow path, the output fluid flow path, and the insulating fluid flow path is a negative space; and wherein the insulating fluid flow path is disposed in between the input fluid flow path and the output fluid flow path; and wherein the insulating fluid flow path receives a gas that is substantially stagnant.

Example 6 is an assembly as in any of Examples 1-5, wherein the sidewall of the counterflow heat exchanger is further formed by an interior wall comprising: an input portion comprising an input opening formed in the interior wall; and an output portion comprising an output opening formed in the interior wall; wherein input gas enters the interior of the hollow cylindrical geometry via the input opening formed in the interior wall; and wherein the oxygen-deficient output gas exits the interior of the hollow cylindrical geometry via the output opening formed in the interior wall.

Example 7 is an assembly as in any of Examples 1-6, further comprising a heater disposed within the interior of the hollow cylindrical geometry of the counterflow heat exchanger, wherein the input gas passes through the heater after entering the interior of the hollow cylindrical geometry via the input opening formed in the interior wall.

Example 8 is an assembly as in any of Examples 1-7, wherein the interior wall comprises a circular or elliptical cross-sectional geometry; wherein the input gas is located within the input portion, and wherein the input portion comprises one-half of the circular or the elliptical cross-sectional geometry, within a tolerance threshold of ten percent; and wherein the oxygen deficient output gas is located within the output portion, and wherein the output portion comprises one-half of the circular or the elliptical cross-sectional geometry, within a tolerance threshold of ten percent.

Example 9 is an assembly as in any of Examples 1-8, wherein the sidewall of the counterflow heat exchanger is further formed by an exterior wall comprising: an input portion comprising an input opening formed in the exterior wall; and an output portion comprising an output opening formed in the exterior wall; wherein the input gas enters the input fluid flow path via the input opening formed in the exterior wall; and wherein the oxygen-deficient output gas exits the output fluid flow path via the output opening formed in the exterior wall.

Example 10 is an assembly as in any of Examples 1-9, wherein the counterflow heat exchanger further comprises: a first spacer; and a second spacer; wherein the first spacer is disposed in between the first external surface of the first sheet and the second internal surface of the second sheet; and wherein the second spacer is disposed adjacent to the first interior surface of the first sheet.

Example 11 is an assembly as in any of Examples 1-10, wherein the counterflow heat exchanger further comprises a third spacer; wherein the second spacer is disposed in between the third exterior surface of the third sheet and the first interior surface of the first sheet; and wherein the third spacer is disposed in between second exterior surface of the second sheet and the third interior surface of the third sheet.

Example 12 is an assembly as in any of Examples 1-11, wherein each of the first spacer, the second spacer, and the third spacer comprises a sheet formed into a spiral formation comprising a longitudinal axis and a longitudinal length; and wherein the longitudinal length of each of the first spacer, the second spacer, and the third spacer is shorter than a total longitudinal length of the counterflow heat exchanger.

Example 13 is an assembly as in any of Examples 1-12, wherein one or more of the first spacer, the second spacer, or the third spacer comprises a spacer sheet formed into a spiral.

Example 14 is an assembly as in any of Examples 1-13, wherein one or more of the first spacer, the second spacer, or the third spacer comprises a plurality of independent spacers.

Example 15 is an assembly as in any of Examples 1-14, wherein each of the plurality of ceramic cells of the electrochemical assembly comprises: an anode; a cathode; and an electrolyte disposed in between the anode and the cathode, wherein the electrolyte is selectively permeable to oxygen ions.

Example 16 is an assembly as in any of Examples 1-15, wherein the input gas comprising oxygen passes in between the plurality of ceramic cells of the electrochemical assembly; wherein the electrochemical assembly outputs the oxygen-deficient output gas into the interior of the hollow cylindrical geometry of the counterflow heat exchanger; and wherein the electrochemical assembly further outputs a purified oxygen gas into an output tube.

Example 17 is an assembly as in any of Examples 1-16, wherein the first inlet receives an input gas comprising oxygen; wherein the second outlet outputs an oxygen-deficient output gas; wherein the counterflow heat exchanger heats the input gas when the input gas moves through the first fluid flow path; and wherein the counterflow heat exchanger cools the oxygen-deficient output gas when the oxygen-deficient output gas moves through the second fluid flow path.

Example 18 is an assembly as in any of Examples 1-17, further comprising a heater disposed within the interior of the hollow cylindrical geometry of the counterflow heat exchanger.

Example 19 is an assembly as in any of Examples 1-18, wherein the sidewall of the counterflow heat exchanger is formed by at least a first sheet formed in a first spiral and a second sheet formed in a second spiral; wherein each of the first sheet and the second is constructed of a metal material; and wherein the first sheet and the second sheet insulate the interior of the hollow cylindrical geometry of the counterflow heat exchanger to reduce a loss of heat output by the heater.

Example 20 is an assembly as in any of Examples 1-19, wherein the sidewall of the counterflow heat exchanger is further formed by at least a spacer disposed in between the first sheet and the second sheet, and wherein the spacer is constructed of an insulating gas-permeable material.

Example 21 is an assembly as in any of Examples 1-20, further comprising a blower disposed externally to the counterflow heat exchanger, wherein the blower feeds the input gas into the input fluid flow path.

Example 22 is an assembly as in any of Examples 1-21, further comprising a stack housing comprising a cuboid geometry, wherein the electrochemical assembly is disposed within the stack housing, and wherein the stack housing is disposed within the interior of the hollow cylindrical geometry defined by the sidewall of the counterflow heat exchanger.

Example 23 is an assembly as in any of Examples 1-22, wherein at least one of the first sheet or the second sheet is constructed of a thermally reflective material.

Example 24 is an assembly. The assembly includes an electrochemical assembly comprising a plurality of ceramic cells. The assembly includes an electrical lead. The assembly includes a refractory layer constructed of an electrically insulating refractory material. The assembly includes an open housing disposed around the electrochemical assembly, wherein the open housing comprises two opposing sides that permit gas flow through the electrochemical assembly. The assembly is such that the open housing applies a compressive force to the electrochemical assembly that causes the electrical lead to maintain contact with the electrochemical assembly.

Example 25 is an assembly as in Example 24, wherein the electrochemical assembly comprises a first terminal plate and a second terminal plate; wherein the plurality of ceramic cells is disposed in between the first terminal plate and the second terminal plate; wherein the electrical lead comprises a first electrical lead that contacts the first terminal plate; and wherein the electrical lead comprises a second electrical lead that contacts the second terminal plate.

Example 26 is an assembly as in any of Examples 24-25, wherein the open housing comprises: a top plate comprising an oxygen output hole disposed therethrough, wherein the oxygen output hole receives an output tube, and wherein the electrochemical assembly outputs purified oxygen gas into the tube; and a bottom plate located opposite to the top plate; wherein the top plate and the bottom plate apply the compressive force to the electrochemical assembly.

Example 27 is an assembly as in any of Examples 24-26, wherein the open housing further comprises: a first side plate oriented substantially perpendicular to each of the top plate and the bottom plate; and a second side plate oriented substantially perpendicular to each of the top plate and the bottom plate, and further oriented substantially parallel to the first side plate.

Example 28 is an assembly as in any of Examples 24-27, wherein at least one of the top plate, the bottom plate, the first side plate, or the second side plate is constructed of an electrically conductive material; and wherein the refractory layer electrically isolates at least a portion of the electrochemical assembly from the electrical lead.

Example 29 is an assembly as in any of Examples 24-28, wherein the refractory layer comprises a first refractory layer and a second refractory layer; wherein a planar surface of each of the first refractory layer and the second refractory layer is oriented substantially parallel to a planar surface of each of the top plate and the bottom plate, within a manufacturing tolerance threshold of ten percent.

Example 30 is an assembly as in any of Examples 24-29, wherein each of the plurality of ceramic cells comprises a planar quadrilateral geometry.

Example 31 is an assembly as in any of Examples 24-30, wherein at least a portion of the plurality of ceramic cells comprises the quadrilateral geometry with one or more chamfered corners or one or more rounded corners.

Example 32 is an assembly as in any of Examples 24-31, wherein the electrochemical assembly comprises: a first terminal plate forming a top end of the electrochemical assembly, wherein the top end is defined as an upper end relative to a direction of flow of a purified oxygen gas output by the electrochemical assembly; a second terminal plate forming a bottom end of the electrochemical assembly relative to the direction of flow of the purified oxygen gas output by the electrochemical assembly; a first side formed by a plurality of first edges of the plurality of cells; a second side formed by a plurality of second edges of the plurality of cells, wherein the second side is located opposite to the first side; a third side formed by a plurality of third edges of the plurality of cells; and a fourth side formed by a plurality of fourth edges of the plurality of cells, wherein the fourth side is located opposite to the third side; wherein the open housing encases each of the first terminal plate, the second terminal plate, and two of the first side, the second side, the third side, or the fourth side.

Example 33 is an assembly as in any of Examples 24-32, further comprising a gas diffuser plate; wherein a planar surface of the gas diffuser plate is oriented substantially perpendicular to a planar surface of either of the top plate or the bottom plate; and wherein the gas diffuser plate comprises a porous material that enables an input gas to flow through the gas diffuser plate and then flow in between the plurality of ceramic cells.

Example 34 is an assembly as in any of Examples 24-33, wherein the gas diffuser plate causes the input gas to move with a slug flow.

Example 35 is an assembly as in any of Examples 24-34, further comprising a heater; wherein at least a portion of the heater is attached to one or more of the first side plate or the second side plate; wherein the heater is disposed adjacent to a gas diffuser plate such that an input gas passes through the heater, and then passes through the gas diffuser plate, and then passes in between the plurality of ceramic cells of the electrochemical assembly.

Example 36 is an assembly as in any of Examples 24-35, wherein the electrochemical assembly comprises a first envelope tolerance prior to the electrochemical assembly being disposed within the housing; wherein the compressive force applied to the electrochemical assembly by the open housing causes the electrochemical assembly to comprise a second envelope tolerance when the electrochemical assembly is disposed within the open housing; and wherein the second envelope tolerance is tighter than the first envelope tolerance.

Example 37 is an assembly as in any of Examples 24-36, wherein the electrical lead provides an electric current to the plurality of ceramic cells; wherein the electric current enables the plurality of ceramic cells to separate oxygen ions from an input gas by creating an electrochemical potential gradient across a surface of each of the plurality of ceramic cells.

Example 38 is an assembly as in any of Examples 24-37, wherein each of the first side plate and the second side plate is constructed from an electrically conductive material; and wherein the refractory layer is constructed from an electrically insulating material such that the refractory layer electrically isolates the plurality of ceramic cells from the first side plate and the second side plate.

Example 39 is an assembly as in any of Examples 24-38, wherein each of the plurality of ceramic cells comprises: an anode; an electrolyte; and a cathode; wherein oxygen ions pass through a crystalline structure of the electrolyte such that the electrochemical assembly outputs purified oxygen gas.

Example 40 is an assembly as in any of Examples 24-39, wherein the electrochemical assembly further comprises a plurality of porous interconnects constructed of a porous and electrically conductive material; and wherein the plurality of interconnects are disposed in between adjacent pairs of ceramic cells of the plurality of ceramic cells to enable electrical communication between the adjacent pairs of ceramic cells.

Example 41 is an assembly as in any of Examples 24-40, wherein each of the plurality of ceramic cells of the electrochemical assembly comprises: an anode cap, wherein the anode cap is sufficiently nonporous to prevent molecular diffusion across a thickness of the anode cap; a porous anode; an electrolyte, wherein the electrolyte is sufficiently nonporous to prevent molecular diffusion across a thickness of the electrolyte; a porous cathode; a cathode edge attached to the porous cathode, wherein the cathode edge is sufficiently nonporous to prevent molecular diffusion across a thickness of the cathode edge; and an anode edge attached to the porous anode, wherein the anode edge is sufficiently nonporous to prevent molecular diffusion across a thickness of the anode edge.

Example 42 is an assembly as in any of Examples 24-41, wherein the electrolyte permits diffusion of oxygen ions across the thickness of the electrolyte.

Example 43 is an assembly as in any of Examples 24-42, wherein each of the plurality of ceramic cells of the electrochemical assembly comprises a planar geometry within a manufacturing tolerance threshold permitting a warping up to 500 micrometers across a surface of a ceramic cell.

Example 44 is an assembly as in any of Examples 24-43, wherein the electrochemical assembly is an electrochemical assembly that receives an input gas comprising oxygen, and outputs each of an oxygen-deficient output gas and a purified oxygen gas.

Example 45 is an assembly as in any of Examples 24-44, wherein the refractory layer is constructed of a rigid electrically insulating refractory material.

Example 46 is an assembly as in any of Examples 24-45, wherein the refractory layer is constructed of a flexible electrically insulating refractory material.

Example 47 is an assembly as in any of Examples 24-46, further comprising an electrically conductive paste, wherein the electrically conductive paste is applied in between the electrical lead and a wall of the open housing, and wherein the electrically conductive paste reduces electrical interference between the electrical lead and the plurality of ceramic cells of the electrochemical stack.

Example 48 is an assembly as in any of Examples 24-47, wherein the electrically conductive paste comprises one or more of silver, gold, platinum, palladium, rhodium, ruthenium, rhenium, or iridium, and wherein the electrically conductive paste is partially or fully sintered.

Example 49 is an assembly as in any of Examples 24-48, wherein the electrically conductive paste comprises one or more of chromium, manganese, iron, cobalt, nickel, copper, zinc, magnesium, sodium, potassium, calcium, hafnium, tantalum, tungsten, thallium, indium, tin, lead, or bismuth.

Example 50 is an assembly as in any of Examples 24-49, wherein the electrically conductive paste comprises a metal oxide powder.

Example 51 is an assembly as in any of Examples 24-50, wherein the stack and the housing are disposed within the counterflow heat exchanger as in any of Examples 1-23.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. An assembly comprising:
an electrochemical assembly comprising a plurality of ceramic cells;
an electrical lead;
a refractory layer constructed of an electrically insulating refractory material; and
an open housing disposed around the electrochemical assembly, wherein the open housing comprises two opposing sides that permit gas flow through the electrochemical assembly;
wherein the open housing applies a compressive force to the electrochemical assembly that causes the electrical lead to maintain contact with the electrochemical assembly.

2. The assembly of claim 1, wherein the electrochemical assembly comprises a first terminal plate and a second terminal plate;
wherein the plurality of ceramic cells is disposed in between the first terminal plate and the second terminal plate;
wherein the electrical lead comprises a first electrical lead that contacts the first terminal plate; and
wherein the electrical lead comprises a second electrical lead that contacts the second terminal plate.

3. The assembly of claim 1, wherein the open housing comprises:
a top plate comprising an oxygen output hole disposed therethrough, wherein the oxygen output hole receives an output tube, and wherein the electrochemical assembly outputs purified oxygen gas into the tube; and
a bottom plate located opposite to the top plate;
wherein the top plate and the bottom plate apply the compressive force to the electrochemical assembly.

4. The assembly of claim 1, wherein the open housing further comprises:
a first side plate oriented substantially perpendicular to each of the top plate and the bottom plate; and
a second side plate oriented substantially perpendicular to each of the top plate and the bottom plate, and further oriented substantially parallel to the first side plate.

5. The assembly of claim 4, wherein at least one of the top plate, the bottom plate, the first side plate, or the second side plate is constructed of an electrically conductive material; and
wherein the refractory layer electrically isolates at least a portion of the electrochemical assembly from the electrical lead.

6. The assembly of claim 3, wherein the refractory layer comprises a first refractory layer and a second refractory layer;
wherein a planar surface of each of the first refractory layer and the second refractory layer is oriented substantially parallel to a planar surface of each of the top plate and the bottom plate, within a manufacturing tolerance threshold of ten percent.

7. The assembly of claim 1, wherein each of the plurality of ceramic cells comprises a planar quadrilateral geometry.

8. The assembly of claim 7, wherein at least a portion of the plurality of ceramic cells comprises the quadrilateral geometry with one or more chamfered corners or one or more rounded corners.

9. The assembly of claim 1, wherein the electrochemical assembly comprises:
a first terminal plate forming a top end of the electrochemical assembly, wherein the top end is defined as an upper end relative to a direction of flow of a purified oxygen gas output by the electrochemical assembly;
a second terminal plate forming a bottom end of the electrochemical assembly relative to the direction of flow of the purified oxygen gas output by the electrochemical assembly;
a first side formed by a plurality of first edges of the plurality of cells;
a second side formed by a plurality of second edges of the plurality of cells, wherein the second side is located opposite to the first side;
a third side formed by a plurality of third edges of the plurality of cells; and
a fourth side formed by a plurality of fourth edges of the plurality of cells, wherein the fourth side is located opposite to the third side;
wherein the open housing encases each of the first terminal plate, the second terminal plate, and two of the first side, the second side, the third side, or the fourth side.

10. The assembly of claim 3, further comprising a gas diffuser plate;
wherein a planar surface of the gas diffuser plate is oriented substantially perpendicular to a planar surface of either of the top plate or the bottom plate; and
wherein the gas diffuser plate comprises a porous material that enables an input gas to flow through the gas diffuser plate and then flow in between the plurality of ceramic cells.

11. The assembly of claim 10, wherein the gas diffuser plate causes the input gas to move with a slug flow.

12. The assembly of claim 4, further comprising a heater;
wherein at least a portion of the heater is attached to one or more of the first side plate or the second side plate;
wherein the heater is disposed adjacent to a gas diffuser plate such that an input gas passes through the heater, and then passes through the gas diffuser plate, and then passes in between the plurality of ceramic cells of the electrochemical assembly.

13. The assembly of claim 1, wherein the electrochemical assembly comprises a first envelope tolerance prior to the electrochemical assembly being disposed within the housing;
wherein the compressive force applied to the electrochemical assembly by the open housing causes the electrochemical assembly to comprise a second envelope tolerance when the electrochemical assembly is disposed within the open housing; and
wherein the second envelope tolerance is tighter than the first envelope tolerance.

14. The assembly of claim 1, wherein the electrical lead provides an electric current to the plurality of ceramic cells;
wherein the electric current enables the plurality of ceramic cells to separate oxygen ions from an input gas by creating an electrochemical potential gradient across a surface of each of the plurality of ceramic cells.

15. The assembly of claim 4, wherein each of the first side plate and the second side plate is constructed from an electrically conductive material; and
wherein the refractory layer is constructed from an electrically insulating material such that the refractory layer electrically isolates the plurality of ceramic cells from the first side plate and the second side plate.

16. The assembly of claim 1, wherein each of the plurality of ceramic cells comprises:
an anode;
an electrolyte; and
a cathode;
wherein oxygen ions pass through a crystalline structure of the electrolyte such that the electrochemical assembly outputs purified oxygen gas.

17. The assembly of claim 16, wherein the electrochemical assembly further comprises a plurality of porous interconnects constructed of a porous and electrically conductive material; and
wherein the plurality of interconnects are disposed in between adjacent pairs of ceramic cells of the plurality of ceramic cells to enable electrical communication between the adjacent pairs of ceramic cells.

18. The assembly of claim 1, wherein each of the plurality of ceramic cells of the electrochemical assembly comprises:
an anode cap, wherein the anode cap is sufficiently nonporous to prevent molecular diffusion across a thickness of the anode cap;
a porous anode;
an electrolyte, wherein the electrolyte is sufficiently nonporous to prevent molecular diffusion across a thickness of the electrolyte;
a porous cathode;
a cathode edge attached to the porous cathode, wherein the cathode edge is sufficiently nonporous to prevent molecular diffusion across a thickness of the cathode edge; and
an anode edge attached to the porous anode, wherein the anode edge is sufficiently nonporous to prevent molecular diffusion across a thickness of the anode edge.

19. The assembly of claim 18, wherein the electrolyte permits diffusion of oxygen ions across the thickness of the electrolyte.

20. The assembly of claim 1, wherein each of the plurality of ceramic cells of the electrochemical assembly comprises a planar geometry within a manufacturing tolerance threshold permitting a warping up to 500 micrometers across a surface of a ceramic cell.

21. The assembly of claim 1, wherein the electrochemical assembly is an electrochemical assembly that receives an input gas comprising oxygen, and outputs each of an oxygen-deficient output gas and a purified oxygen gas.

22. The assembly of claim 1, wherein the refractory layer is constructed of a rigid electrically insulating refractory material.

23. The assembly of claim 1, wherein the refractory layer is constructed of a flexible electrically insulating refractory material.

24. The assembly of claim 1, further comprising an electrically conductive paste, wherein the electrically conductive paste is applied in between the electrical lead and a wall of the open housing, and wherein the electrically conductive paste reduces electrical interference between the electrical lead and the plurality of ceramic cells of the electrochemical stack.

25. The assembly of claim 24, wherein the electrically conductive paste comprises one or more of silver, gold, platinum, palladium, rhodium, ruthenium, rhenium, or iridium, and wherein the electrically conductive paste is partially or fully sintered.

26. The assembly of claim 24, wherein the electrically conductive paste comprises one or more of chromium, manganese, iron, cobalt, nickel, copper, zinc, magnesium, sodium, potassium, calcium, hafnium, tantalum, tungsten, thallium, indium, tin, lead, or bismuth.

27. The assembly of claim 24, wherein the electrically conductive paste comprises a metal oxide powder.
